(19) United States
(12) Patent Application Publication
(10) Pub. No.: US 2009/0043081 A1
(43) Pub. Date: Feb. 12, 2009

(54) INK JET RECORDING SET AND INK JET RECORDING METHOD

(75) Inventors: Yoshimitsu Arai, Shizuoka (JP); Ryoichi Nakano, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 12/162,938

(22) PCT Filed: Jan. 22, 2007
(86) PCT No.: PCT/JP2007/051320

§ 371 Date: Jul. 31, 2008

(30) Foreign Application Priority Data
Feb. 2, 2006 (JP) 2006-026376

(51) Int. Cl. C09B 62/006

(52) U.S. Cl. 534/617

(57) ABSTRACT

An ink jet recording set including: an ink jet recording medium, containing a water-soluble aluminum compound and a sulfoxide compound in an ink-receiving layer on a support; and an ink, containing a dye represented by the following formula (1). In formula (1), A represents a 5-membered heterocyclic group. B¹ and B² each represent —CR¹═ and —CR²═, or one represents a nitrogen atom, and the other represents —CR¹═ or —CR²═. R³ and R⁴ each independently represent a hydrogen atom, an aliphatic group, an aromatic group, a heterocyclic group, or the like. R¹ and R² each independently represent a hydrogen atom, a halogen atom, an aliphatic group, an aromatic group, a heterocyclic group, or the like. a and e each independently represent an alkyl group, an alkoxy group, or a halogen atom. b, c, and d are each independently has the same definitions as R¹ and R². Formula (1) has at least one ionic hydrophilic group.

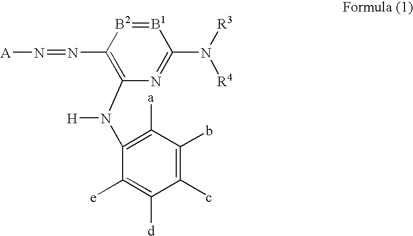

### TECHNICAL FIELD

The present invention relates to an ink jet recording set capable of forming an image having excellent ozone resistance, and an ink jet recording method using the same.

### BACKGROUND ART

Recently, materials for forming color images in particular are mainstream as image recording materials. More specifically, these are being popularly used as ink jet recording materials, heat-sensitive transfer recording materials, electrophotographic method recording materials, transfer-type silver halide photosensitive materials, printing inks, recording pens, and the like.

In these color image recording materials, dyes or pigments of the three primary colors are used in order to reproduce or record a full-color image according to the so-called subtractive color-mixing method. However, the reality is that there are no fast dyes which have absorption properties capable of realizing preferred color reproducing regions and also capable of withstanding various conditions of use. Improvements in such points are strongly desired.

Inkjet recording methods have rapidly become widespread and are continuing to develop due to the low material cost, ability to undertake high-speed recording, low noise during printing, and ease of color recording.

The inkjet recording methods include continuous methods of producing a continuous stream of droplets and on-demand methods of releasing droplets corresponding to an image information signal. The ejection methods thereof include: methods of ejecting droplets upon application of pressure by piezo elements; methods of ejecting droplets upon generation of bubbles in the ink by heat; methods of using ultrasonic waves; and methods of sucking and ejecting droplets by electrostatic force. As inkjet recording ink, aqueous inks, oil-based inks, or solid (melt-type) inks are employed.

The coloring agent used in these inkjet recording inks is required to have good solubility or dispersibility in a solvent, be capable of high-density recording, provide a good hue, have fastness against light, heat and active gases in the environment (for example, oxidative gases such as NOₓ, ozone, and SOₓ), exhibit excellent fastness to water and chemicals, give good adhering properties to an image-receiving material and not bleed easily, give an ink having excellent storability, have no toxicity and high purity, and, further, be available at a low cost. However, it is very difficult to seek out a coloring agent which satisfies these requirements at high levels. In particular, coloring agents are strongly desired with a good hue of the three primary colors, fastness against light, moisture, and heat, and fastness against oxidative gases such as ozone during printing on an image-receiving material having an ink-receiving layer.

Heretofore, as magenta dyes, azo dyes in which phenol, naphthol, aniline, or the like is used as the coupling component have been broadly used. Azo dyes having a good hue are known (e.g., Japanese Patent Application Laid-Open (JP-A) No. 11-209673 and U.S. Pat. No. 3,020,660), however, they have poor light-fastness. In order to solve the problem, a dye having a good hue and improved light-fastness has recently been disclosed (JP-A No. 2000-220649). However, these dyes disclosed in the above patents have extremely poor fastness against oxidative gases such as ozone.

Typical cyan dyes are phthalocyanine dyes and triphenyl methane dyes. The most broadly used phthalocyanine-based dyes, which are represented by C. I. Direct Blue 86, 87, and 199, are superior in light resistance to magenta and yellow dyes, however, they show significant discoloring or fading by oxidative gases such as nitrogen oxide gases and ozone, often mentioned as environmental problems.

Phthalocyanine-based dyes imparted with ozone gas resistance have up to now been reported (see JP-A Nos. 3-103484, 4-39365, and 2000-303009), however they all still have very poor fastness to oxidative gases, and further improvement is desired.

Triphenylmethane-based dyes, such as Acid Blue 9, have good hue, however have significantly poor resistance to light and ozone gas.

As yellow dyes, azobenzene-based dyes such as Direct Yellow 86 and 120, pyrazolone azo dyes such as Acid Yellow 17, and heterocyclic azo dyes such as pyridone azo dyes have been used. Quinophthalone-based dyes are also often suggested. Among these known dyes, however, quinophthalone dyes having a good hue, particularly those superior in the absorbance cut-off at the long wavelength side of an absorption spectrum, often are not fast to ozone and light. Azobenzene-based dyes have fastness, however, they exhibit poor absorbance cut-off at the long wavelength side.

In order to obtain a full color image having fastness and excellent color reproducibility, dyes forming an image are required to meet the following requirements:

have excellent absorption properties for dyes of three primary colors;

be appropriately combinable as dyes of three primary colors to realize a broad color reproducing region;

have dyes of three primary colors each with high fastness;

generate no deterioration of fastness of dyes by interaction between the dyes; and have well-balanced fastness between the dyes of three primary colors.

However, as to fastness, especially fastness to oxidative gases such as ozone, which recently has been a big problem in ink jet printing, there are absolutely no reports regarding the properties of dyes, for example the structure or physical properties, that are effective in achieving fastness to ozone. Accordingly, at present there are no pointers for selecting dyes having fastness to such oxidative gases. Furthermore, it is even more difficult to select a dye which also has fastness to light.

There is an ink-receiving layer for ink jet recording medium which contains fine particles in a water-soluble resin. The ink-receiving layer contains fine particles so as to have a porous structure, and thereby improve ink absorption performance. However, such an ink-receiving layer has insufficient ozone resistance due to its porous structure.

The use of sulfur-based additives for improving ozone resistance has already been reported (see e.g., JP-A Nos. 2002-86904, 2002-36717, 2001-260519, and 7-314882). However, while the use of such additives improves ozone resistance as compared with the cases in which the sulfur-based additive was not used, the level of performance is not necessarily satisfactory.

As a technique for improving the ozone resistance of an ink jet recording medium, for example, a method of including a sulfoxide compound and a water-soluble polyvalent metal salt in an ink-receiving layer of an ink jet recording medium is disclosed in JP-A No. 2005-7849.

However, depending on the dye used a satisfactory effect is not sometimes obtained.

A technique for improving ozone resistance by defining a magenta dye used in an ink by its oxidation potential is disclosed in JP-ANo. 2004-299373.

However, while the use of this technique improves ozone resistance in comparison with when the technique was not used, the level of performance is not necessarily satisfactory.

### DISCLOSURE OF THE INVENTION

An ink jet recording set capable of forming an image having excellent ozone resistance or the like, and an ink jet recording method using the same have been demanded.

The present invention has been made in view of the above-described situation, and provides an inkjet recording set and an ink jet recording method using the same.

According to an aspect of the invention, there is provided an ink jet recording set including: an ink jet recording medium containing a water-soluble aluminum compound and a sulfoxide compound in an ink-receiving layer on a support; and an ink containing a dye represented by the following formula (1).

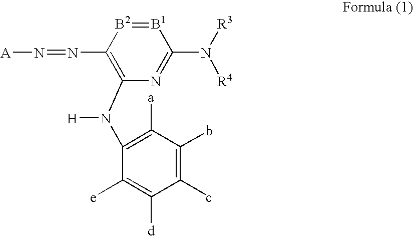

In formula (1), A represents a 5-membered heterocyclic group; B¹ and B² each represent —CR¹═ and —CR²═, or one represents a nitrogen atom, and the other represents —CR¹═ or —CR²═; R¹ and R⁴ each independently represent a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group, or a sulfamoyl group; R¹ and R² each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclic amino group, an acylamino group, an ureido group, a sulfamoylamino group, an alkoxycarbonylamino group, an aryloxycarbonyl amino group, an alkylsulfonyl amino group, an arylsulfonyl amino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group; R¹ and R² may be bonded to each other to form a 5- or 6-membered ring; R³ and R⁴ may be bonded to each other to form a 5- or 6-membered ring; a and e each independently represents an alkyl group, an alkoxy group, or a halogen atom; when a and e are each an alkyl group, the alkyl groups have 3 or more carbons in total, and they may be further substituted; b, c, and d each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclic amino group, an acylamino group, an ureido group, a sulfamoylamino group, an alkoxycarbonylamino group, an aryloxycarbonyl amino group, an alkylsulfonyl amino group, an arylsulfonyl amino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group; a and b may be fused with each other to form a ring; e and d may be fused with each other to form a ring; and formula (1) has at least one ionic hydrophilic group.

According to another aspect of the invention, there is provided an ink jet recording method including forming an image using the ink jet recording set of an aspect of the invention.

### BEST MODE FOR CARRYING OUT THE INVENTION

The ink jet recording set of the invention includes an ink jet recording medium containing a water-soluble aluminum compound and a sulfoxide compound in an ink-receiving layer on a support, and an ink containing a dye represented by the following formula (1).

The ink jet recording set of the invention exhibits excellent ozone resistance by including an ink jet recording medium containing a water-soluble aluminum compound and a sulfoxide compound, and an ink containing a dye represented by formula (1).

The ink and ink jet recording medium of the ink jet recording set of the invention are described in more detail below.

Ink

The ink in the invention contains at least the dye represented by the following formula (1), and if necessary, may contain other additive(s).

Dye Represented by Formula (1)

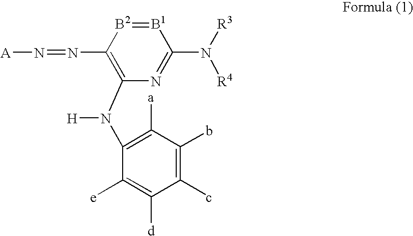

In formula (1), A represents a 5-membered heterocyclic group. B1 and B2 each represent —CR¹═ and —CR²═, or one represents a nitrogen atom, and the other represents —CR¹=or —CR²═. R³ and R⁴ each independently represent a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group, or a sulfamoyl group.

R¹ and R² each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclic amino group, an acylamino group, an ureido group, a sulfamoylamino group, an alkoxycarbonylamino group, an aryloxycarbonyl amino group, an alkylsulfonyl amino group, an arylsulfonyl amino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group.

Furthermore, R¹ and R² may be bonded to each other to form a 5- or 6-membered ring, or R³ and R⁴ may be bonded to each other to form a 5- or 6-membered ring.

a and e each independently represents an alkyl group, an alkoxy group, or a halogen atom. When both of a and e are an alkyl group, the alkyl groups have 3 or more carbons in total, and they may be further substituted. b, c, and d each independently have the same definitions as R¹ and R², a and b may be fused with each other to form a ring, or e and d may be fused with each other to form a ring. Formula (1) has at least one ionic hydrophilic group.

Formula (1) is described in more detail.

In the azo dye (compound) represented by formula (1), A represents a 5-membered heterocyclic group. Examples of the heteroatom of the 5-membered heterocyclic group include N, O, and S, Nitrogen-containing 5-membered heterocycle is preferable, and the heterocycle may be fused with an aliphatic ring, aromatic ring, or other heterocycles.

Preferred examples of the heterocycle A include a pyrazole ring, an imidazole ring, a triazole ring, a thiazole ring, an isothiazole ring, a thiadiazole ring, a benzothiazole ring, a benzoxazole ring, and a benzoisothiazole ring. These heterocyclic groups may have another substituent. Among these heterocycles, pyrazole rings, imidazole rings, isothiazole rings, thiadiazole rings, benzothiazole rings, and triazole rings represented by the following formulae (a) through (g) are preferable.

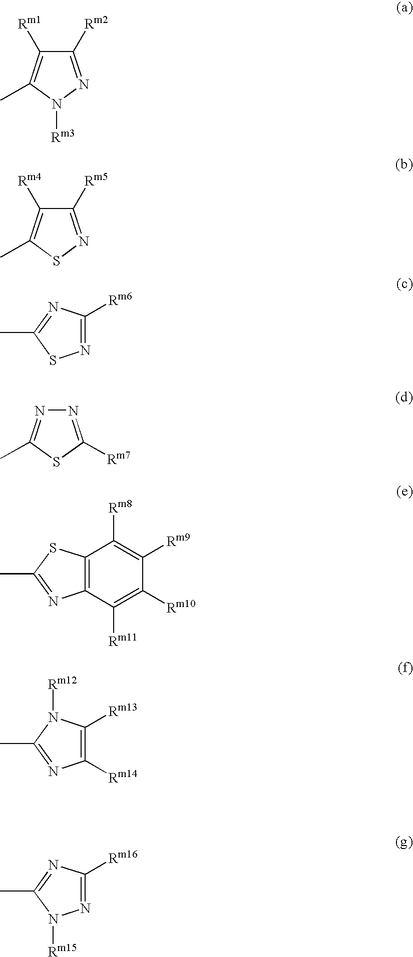

In the above formulae (a) through (g), R^{m1} to R^{m16} have the same definitions as R¹ or R² in formula (1).

Examples of the preferable substituent represented by R¹ or R² include a hydrogen atom, an alkyl group, an alkoxycarbonyl group, a carboxyl group, a carbamoyl group, and a cyano group. These groups may have another substituent. Examples of another substituent of the substituent represented by A, R¹, R², R³ or R⁴ include the substituents listed for the above-described R¹ and R².

When the azo dye represented by formula (1) is a water-soluble dye, it is preferable that the position A, R¹, R², R³, or R⁴ has an ionic hydrophilic group as a substituent. Examples of the ionic hydrophilic group as a substituent include a sulfo group, a carboxyl group, and a quaternary ammonium group. As the ionic hydrophilic group, a carboxyl group and a sulfo group are preferable, and a sulfo group is particularly preferable. The carboxyl group and sulfo group may be in a salt form, and examples of the counter ion forming the salt include alkaline metal ions (e.g., sodium ion and potassium ion) and organic cations (e.g., tetramethyl guanidium ion).

The substituents represented by R¹ or R² are described below in detail.

Examples of the halogen atom include a fluorine atom, a chlorine atom, and a bromine atom.

In the present description, the term aliphatic group means an alkyl group, a substituted alkyl group, an alkenyl group, a substituted alkenyl group, an alkynyl group, a substituted alkynyl group, an aralkyl group, and a substituted aralkyl group. The aliphatic group may be branched, or form a ring.

The aliphatic group has preferably 1 to 20 carbon atoms, and more preferably 1 to 16 carbon atoms. The aryl moiety of the aralkyl group and the substituted aralkyl group is preferably phenyl or naphthyl, and particularly preferably phenyl.

Examples of the aliphatic group include methyl, ethyl, butyl, isopropyl, t-butyl, hydroxyethyl, methoxyethyl, cyanoethyl, trifluoromethyl, 3-sulfopropyl, 4-sulfobutyl, a cyclohexyl group, a benzyl group, a 2-phenethyl group, a vinyl group, and an allyl group.

In the present description, the term aromatic group means an aryl group and a substituted aryl group. The aryl group is preferably phenyl or naphthyl, and particularly preferably phenyl. The aromatic group has preferably 6 to 20 carbon atoms, and more preferably 6 to 16 carbon atoms. Examples of the aromatic group include phenyl, p-tolyl, p-methoxyphenyl, o-chlorophenyl, and m-(3-sulfopropylamino)phenyl.

In the present description, the heterocyclic group includes a heterocyclic group having a substituent and an unsubstituted heterocyclic group. The heterocycle may be fused with an aliphatic ring, an aromatic ring, or other heterocycles.

As the heterocyclic group, a 5-membered or 6-membered heterocyclic group is preferable. Examples of the substituent include an aliphatic group, a halogen atom, an alkylsulfonyl group, an arylsulfonyl group, an acyl group, an acylamino group, a sulfamoyl group, a carbamoyl group, and an ionic hydrophilic group. Examples of the heterocyclic group include a 2-pyridyl group, a 2-thienyl group, a 2-thiazolyl group, a 2-benzothiazolyl group, a 2-benzooxazolyl group, and a 2-furyl group.

The carbamoyl group includes a carbamoyl group having a substituent and an unsubstituted carbamoyl group. Examples of the substituent include an alkyl group. Examples of the carbamoyl group include a methylcarbamoyl group and a dimethylcarbamoyl group.

The alkoxycarbonyl group includes an alkoxycarbonyl having a substituent and an unsubstituted alkoxycarbonyl group. As the alkoxycarbonyl group, an alkoxycarbonyl group having 2 to 12 carbon atoms is preferable. Examples of the substituent include an ionic hydrophilic group. Examples of the alkoxycarbonyl group include a methoxycarbonyl group and an ethoxycarbonyl group.

The aryloxycarbonyl group includes an aryloxycarbonyl having a substituent and an unsubstituted aryloxycarbonyl group. As the aryloxycarbonyl group, an aryloxycarbonyl group having 7 to 12 carbon atoms is preferable. Examples of the substituent include an ionic hydrophilic group. Examples of the aryloxycarbonyl group include a phenoxycarbonyl group.

The acyl group includes an acyl groups having a substituent and an unsubstituted acyl group. As the acyl group, an acyl group having 1 to 12 carbon atoms is preferable. Examples of the substituent include an ionic hydrophilic group. Examples of the acyl group includes an acetyl group and a benzoyl group.

The alkoxy group includes an alkoxy group having a substituent and an unsubstituted alkoxy group. As the alkoxy group, an alkoxy group having 1 to 12 carbon atoms is preferable. Examples of the substituent include an alkoxy group, a hydroxyl group, and an ionic hydrophilic group. Examples of the alkoxy group include a methoxy group, an ethoxy group, an isopropoxy group, a methoxy ethoxy group, a hydroxyethoxy group, and a 3-carboxypropoxy group.

The aryloxy group includes an aryloxy group having a substituent and an unsubstituted aryloxy group. As the aryloxy group, an aryloxy group having 6 to 12 carbon atoms is preferable. Examples of the substituent include an alkoxy group and an ionic hydrophilic group. Examples of the aryloxy group include a phenoxy group, a p-methoxyphenoxy group, and an o-methoxyphenoxy group.

The silyloxy group includes a silyloxy group having a substituent and an unsubstituted silyloxy group. Examples of the substituent include an alkyl group having 1 to 6 carbon atoms. Examples of the silyloxy group include a trimethylsilyloxy group, and a dibutylmethylsilyloxy group.

The acyloxy group includes an acyloxy group having a substituent and an unsubstituted acyloxy group. As the acyloxy group, an acyloxy group having 1 to 12 carbon atoms is preferable. Examples of the substituent include an ionic hydrophilic group. Examples of the acyloxy group include an acetoxy group and a benzoyloxy group.

The carbamoyloxy group includes a carbamoyloxy group having a substituent and an unsubstituted carbamoyloxy group. Examples of the substituent include an alkyl group. Examples of the carbamoyloxy group include a N-methylcarbamoyloxy group.

The heterocyclic oxy group includes an oxy group having a substituted heterocyclic group and an oxy group having an unsubstituted heterocyclic group. Examples of the substituents include the substituents listed for the above-described heterocyclic group. Examples of the heterocyclic oxy group include a 2-pyridyloxy group, a 2-thienyloxy group, a 2-thiazolyloxy group, a 2-benzothiazolyloxy group, a 2-benzooxazolyloxy group, and a 2-furyloxy group.

The alkoxycarbonyloxy group includes an alkoxycarbonyloxy group having a substituent and an unsubstituted alkoxycarbonyloxy group. As the alkoxycarbonyloxy group, an alkoxycarbonyloxy group having 2 to 12 carbon atoms is preferable. Examples of the substituent include an ionic hydrophilic group. Examples of the alkoxycarbonyl group include a methoxycarbonyloxy group and an ethoxycarbonyloxy group.

The aryloxycarbonyloxy group includes an aryloxycarbonyloxy group having a substituent and an unsubstituted aryloxycarbonyloxy group. As the aryloxycarbonyloxy group, an aryloxycarbonyloxy group having 7 to 12 carbon atoms is preferable. Examples of the substituent include an ionic hydrophilic group. Examples of the aryloxycarbonyloxy group include a phenoxycarbonyloxy group.

The substituent of the amino group substituted by an alkyl group, an aryl group, or a heterocyclic group may have another substituent. Unsubstituted amino groups are not included. As the alkylamino group, an alkylamino group having 1 to 6 carbon atoms is preferable. Examples of the substituent include an ionic hydrophilic group.

Examples of the alkylamino group include methylamino group and diethylamino group. The arylamino group includes an arylamino group having a substituent and an unsubstituted arylamino group.

As the arylamino group, an arylamino group having 6 to 12 carbon atoms is preferable. Examples of the substituent include a halogen atom, and an ionic hydrophilic group. Examples of the arylamino group include an anilino group and a 2-chloroanilino group.

The heterocyclic amino group includes an amino group having a heterocyclic group with a substituent and an amino group having an unsubstituted heterocyclic group. Examples of the substituent include the substituents listed for the above-described heterocyclic group. Examples of the heterocyclic amino group include a 2-pyridylamino group, a 2-thienylamino group, a 2-thiazolylamino group, a 2-benzothiazolylamino group, a 2-benzooxazolylamino group, and a 2-furyl amino group.

The acylamino group includes an acylamino group having a substituent. As the acylamino group, an acylamino group having 2 to 12 carbon atoms is preferable. Examples of the substituent include an ionic hydrophilic group. Examples of the acylamino group include an acetyl amino group, a propionyl amino group, a benzoyl amino group, a N-phenylacetylamino group, and a 3,5-disulfobenzoylamino group.

The ureido group includes an ureido group having a substituent and an unsubstituted ureido group. As the above-described ureido group, an ureido group having 1 to 12 carbon atoms is preferable. Examples of the substituent include an alkyl group and an aryl group. Examples of the ureido group include a 3-methylureido group, a 3,3-dimethylureido group, and a 3-phenylureido group.

The sulfamoylamino group includes a sulfamoylamino having a substituent and an unsubstituted sulfamoylamino group. Examples of the substituent include an alkyl group. Examples of the sulfamoylamino group include a N,N-dipropylsulfamoylamino group.

The alkoxycarbonylamino group includes an alkoxycarbonylamino group having a substituent and an unsubstituted alkoxycarbonylamino group. As the alkoxycarbonylamino group, an alkoxycarbonylamino group having 2 to 12 carbon atoms is preferable. Examples of the substituent include an ionic hydrophilic group. Examples of the alkoxycarbonylamino group include an ethoxycarbonylamino group.

Examples of the aryloxycarbonylamino group include an aryloxycarbonylamino group having a substituent and an unsubstituted aryloxycarbonylamino group. As the aryloxycarbonylamino group, an aryloxycarbonylamino group having 7 to 12 carbon atoms is preferable. Examples of the substituent include an ionic hydrophilic group. Examples of the aryloxycarbonylamino group include a phenoxycarbonylamino group.

The alkylsulfonylamino and arylsulfonylamino groups include an alkylsulfonylamino group having a substituent, an arylsulfonylamino group having a substituent, an unsubstituted alkylsulfonylamino group and an unsubstituted arylsulfonylamino group. As the alkylsulfonylamino group, an alkylsulfonylamino group having 1 to 12 carbon atoms is preferable, and as the arylsulfonylamino group, an arylsulfonyl group having 6 to 12 carbon atoms is preferable. Examples of the substituent include an ionic hydrophilic group. Examples of the alkylsulfonylamino group and arylsulfonylamino group include a methanesulfonylamino group, an N-phenylmethanesulfonylamino group, a benzenesulfonylamino group, and a 3-carboxybenzenesulfonylamino group.

The thio group substituted by an alkyl, aryl, or heterocyclic group includes an alkyl thio group having a substituent, an aryl thio group having a substituent, and a heterocyclic thio group having a substituent, an unsubstituted alkyl thio group, an substituted aryl thio group and an unsubstituted heterocyclic thio group. As the alkyl thio group, aryl thio group, and heterocyclic thio group, those having 1 to 12 carbon atoms are preferable. Examples of the substituent include an ionic hydrophilic group. Examples of the alkyl thio group, aryl thio group, and heterocyclic thio group include a methylthio group, a phenylthio group, and a 2-pyridylthio group.

Examples of the alkylsulfonyl group and arylsulfonyl group include a methanesulfonyl group and a phenylsulfonyl group, respectively. Examples of the alkylsulfinyl group and arylsulfinyl group include a methanesulfinyl group and a phenylsulfinyl group, respectively.

The sulfamoyl group includes a sulfamoyl group having a substituent and an unsubstituted sulfamoyl group. Examples of the substituent include an alkyl group. Examples of the sulfamoyl group include a dimethylsulfamoyl group and a di-(2-hydroxyethyl)sulfamoyl group.

Among the dyes represented by the above-described formula (1), the dye represented by the following formula (2) is more preferable.

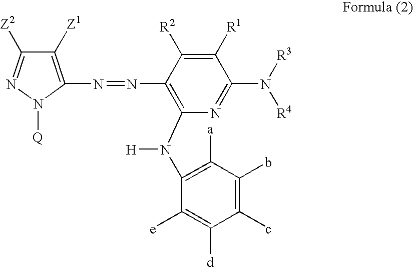

In formula (2), Z¹ represents an electron-withdrawing group having a Hammett's substituent constant σp value of 0.20 or more. Z² represents a hydrogen atom, an aliphatic group, an aromatic group, or a heterocyclic group. Q represents a hydrogen atom, an aliphatic group, an aromatic group, or a heterocyclic group.

R³ and R⁴ each independently represent a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group, or a sulfamoyl group.

R¹ and R² each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclicamino group, an acylamino group, an ureido group, a sulfamoylamino group, an alkoxycarbonylamino group, an aryloxycarbonylamino group, an alkylsulfonylamino group, an aryl sulfonylamino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group. R¹ and R² may be bonded to each other to form a 5-membered or 6-membered ring, or R³ and R⁴ may be bonded to each other to form a 5-membered or 6-membered ring.

a and e each independently represent an alkyl group, an alkoxy group, or a halogen atom. When both a and e are each an alkyl group, the alkyl groups have 3 or more carbon atoms in total, and may be further substituted. b, c, and d are each independently have the same definitions as R¹ and R², and a and b may be fused with each other to form a ring, or, e and d may be fused with each other to form a ring.

Formula (1) has at least one ionic hydrophilic group.

Formula (2) is described in more detail below. In formula (2), Z¹ represents an electron-withdrawing group having a Hammett's substituent constant up value of 0.20 or more.

The above-described electron-withdrawing group of Z¹ is an electron-withdrawing group having a Hammett's substituent constant σp value of 0.20 or more, and preferably 0.30 or more. The upper limit of the σp value is preferably 1.0 or less.

Specific examples of the electron-withdrawing group having a σp value of 0.20 or more include an acyl group, an acyloxy group, a carbamoyl group, an alkyloxycarbonyl group, an aryloxycarbonyl group, a cyano group, a nitro group, a dialkylphosphono group, a diarylphosphono group, a diarylphosphinyl group, an alkylsulfinyl group, an arylsulfinyl group, an alkylsulfonyl group, an arylsulfonyl group, a sulfonyloxy group, an acylthio group, a sulfamoyl group, a thiocyanate group, a thiocarbonyl group, a halogenated alkyl group, a halogenated alkoxy group, a halogenated aryloxy group, a halogenated alkylamino group, a halogenated alkylthio group, a heterocyclic group, a halogen atom, an azo group, a selenocyanate group, and an aryl group substituted by another electron-withdrawing group having a σp value of 0.20 or more. Z¹ is preferably a cyano group, a nitro group, or a halogen atom, more preferably a halogen atom or a cyano group, and particularly preferably a cyano group.

Z² represents a hydrogen atom, an aliphatic group, an aromatic group, or a heterocyclic group. As the Z², a hydrogen atom, an alkyl group, a cycloalkyl group, an aralkyl group, an aryl group, a heterocyclic group, an acyl group, an alkenyl group, or a sulfonyl group are preferable, and an alkyl group is more preferable. These substituents may be further substituted.

The alkyl group includes an alkyl group having a substituent and an unsubstituted alkyl group. The alkyl group is preferably an alkyl group having 1 to 12 carbon atoms excluding the carbon atom(s) of the substituent, more preferably an alkyl group having 1 to 6 carbon atoms. Examples of the substituent include a hydroxyl group, an alkoxy group, a cyano group, a halogen atom, and an ionic hydrophilic group. Examples of the alkyl group include methyl, ethyl, butyl, isopropyl, t-butyl, hydroxyethyl, methoxyethyl, cyanoethyl, trifluoromethyl, 3-sulfopropyl, and 4-sulfobutyl.

The cycloalkyl group includes a cycloalkyl group having a substituent and an unsubstituted cycloalkyl group. As the cycloalkyl group, a cycloalkyl group having 5 to 12 carbon atoms excluding the carbon atoms of the substituent is preferable. Examples of the substituent include an ionic hydrophilic group. Examples of the cycloalkyl group include a cyclohexyl group.

The aralkyl group includes an aralkyl group having a substituent and an unsubstituted aralkyl group. As the aralkyl group, an aralkyl group having 7 to 12 carbon atoms removing the carbon atoms of the substituent is preferable. Examples of the substituent include an ionic hydrophilic group. Examples of the aralkyl group include a benzyl group and a 2-phenethyl group.

The aryl group includes an aryl group having a substituent and an unsubstituted aryl group. As the aryl group, an aryl group having 6 to 12 carbon atoms excluding the carbon atoms of the substituent is preferable. Examples of the substituent include an alkyl group, an alkoxy group, a halogen atom, an alkylamino group, an amide group, a carbamoyl group, a sulfamoyl group, a sulfonamide group, a hydroxy group, an ester group, and ionic hydrophilic group. Examples of the aryl group include phenyl, p-tolyl, p-methoxyphenyl, o-chlorophenyl, and m-(3-sulfopropylamino)phenyl.

The heterocyclic group includes a heterocyclic group having a substituent and an unsubstituted heterocyclic group. As the heterocyclic group, a 5-membered or 6-membered heterocyclic group is preferable. Examples of the substituent include an amide group, a carbamoyl group, a sulfamoyl group, a sulfonamide group, a hydroxy group, an ester group, and an ionic hydrophilic group. Examples of the heterocyclic group include a 2-pyridyl group, a 2-thienyl group, a 2-thiazolyl group, a 2-benzothiazolyl group, and a 2-furyl group.

Examples of the acyl group include an acyl group having a substituent and an unsubstituted acyl group. As the above-described acyl group, an acyl group having 1 to 12 carbon atoms excluding the carbon atoms of the substituent is preferable. Examples of the substituent include an ionic hydrophilic group. Examples of the acyl group include an acetyl group and a benzoyl group.

The alkenyl group includes an alkenyl having a substituent and an unsubstituted alkenyl group. As the alkenyl group, an alkenyl group having 5 to 12 carbon atoms excluding the carbon atoms of the substituent is preferable. Examples of the substituent include an ionic hydrophilic group. Examples of the alkenyl group include a vinyl group, and an allyl group.

Examples of the sulfonyl group include an alkylsulfonyl group such as methanesulfonyl group, and arylsulfonyl group such as phenylsulfonyl group.

It is impossible that both of R³ and R⁴ are a hydrogen atom.

Q represents a hydrogen atom, an aliphatic group, an aromatic group, or a heterocyclic group, and preferably an alkyl group, a cycloalkyl group, an aralkyl group, an alkenyl group, an aryl group, or a heterocyclic group. These substituents may be further substituted. Details of these substituents are the same as those of the above-described R¹ and R².

Q is preferably an aryl group substituted by an electron-withdrawing group or a heterocyclic group substituted by an electron-withdrawing group.

The Hammett's substituent constant σp value used in the present description is briefly described here. Hammett's rule is an empirical rule proposed by L. P. Hammett in 1935 in order to quantitatively discuss the influences of substituents of benzene derivatives on reactions of the derivatives or equilibrium thereof. At present, this rule is extensively regarded as valid. The substituent constant determined by the Hammett's rule includes a σp value and a cm value, and these values can be found in many general books. For example, these substituent constants are described in detail in “Lange's Handbook of Chemistry”, 12th edition, complied by J. A. Dean, McGraw-Hill (1979), and “Kagakuno Ryoiki (Chemistry Region)”, special number, No. 122, pp. 96-103, Nankodo (1979). In the invention, substituents are limited or explained in terms of their Hammett's substituent constants σp. However, this does not mean that the substituents in the invention are limited to the substituents which have bibliographically known values of σp found in these books, and it is a matter of course that the substituents in the invention include substituents which each have an bibliographically unknown value of σp but may give a value in that range when examined in accordance with Hammett's rule.

The above-described electron-withdrawing group of Q is an electron-withdrawing group having a Hammett's substituent constant σp value of 0.20 or more, preferably 0.30 or more. The upper limit of σp is preferably 1.0 or less.

Specific examples of the electron-withdrawing group having a σp value of 0.20 or more include an acyl group, an acyloxy group, a carbamoyl group, an alkyloxycarbonyl group, an aryloxycarbonyl group, a cyano group, a nitro group, a dialkylphosphono group, a diarylphosphono group, a diarylphosphinyl group, an alkylsulfinyl group, an arylsulfinyl group, an alkylsulfonyl group, an arylsulfonyl group, a sulfonyloxy group, an acylthio group, a sulfamoyl group, a thiocyanate group, a thiocarbonyl group, a halogenated alkyl group, a halogenated alkoxy group, a halogenated aryloxy group, a halogenated alkylamino group, a halogenated alkylthio group, a heterocyclic group, a halogen atom, an azo group, a selenocyanate group, and an aryl group substituted by an other electron-withdrawing group having a σp value of 0.20 or more, and a cyano group, a nitro group, and a halogen atom are preferable. The above-described heterocyclic group may be unsubstituted or substituted by an electron-withdrawing group.

R¹ through R⁴, a, b, c, d, and e have the same definitions as those described for R¹ through R⁴, a, b, c, d, and e of formula (1).

Regarding formula (1), an example of the preferable combinations of substituents is described below.

That is, in an example of preferable combinations of substituents, A is a pyrazole ring, an imidazole ring, an isothiazole ring, a thiadiazole ring, or a benzothiazole ring (among them, a pyrazole ring is preferable), B¹ is an unsubstituted carbon atom, B² is an unsubstituted or alkyl substituted carbon atom, R³ and R⁴ are each a hydrogen atom, an alkyl group, an aralkyl group, an aryl group, a heterocyclic group, a sulfonyl group, or an acyl group, and a and e are each an alkyl group or a halogen atom. When both of a and e are an alkyl group, they are unsubstituted alkyl groups and the total of the carbon atoms of a and e is 3 or more (preferably 5 or less), and a, b, c, and d are each a hydrogen atom, a halogen atom, an alkyl group, or an ionic hydrophilic group (preferably a hydrogen atom, an alkyl group having 1 to 4 carbon atoms, or an ionic hydrophilic group).

Specific examples of the azo dyes represented by formula (1) or (2) used in the ink jet ink of the invention are listed below, however the invention is not limited to the following examples.

TABLE 1

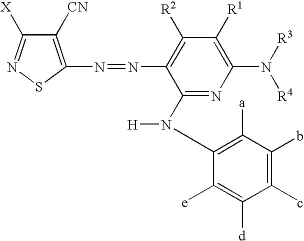

| Compound | X | R¹ | R² | R³ | R⁴ | a | b | c | d | e |
|---|---|---|---|---|---|---|---|---|---|---|
| a-1 | CH₃ | CN | CH₃ | H | 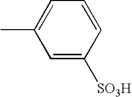 | CH₃ | H | SO₃H | H | C₂H₅ |
| a-2 | ″ | CONH₂ | H | ″ | 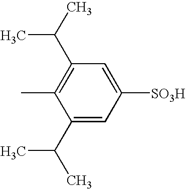 | iPr | ″ | ″ | ″ | iPr |
| a-3 | ″ | H | CH₃ | 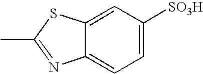 | ″ | ″ | ″ | ″ | ″ | ″ |
| a-4 | ″ | ″ | ″ | ″ | 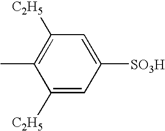 | C₂H₅ | ″ | ″ | ″ | C₂H₅ |
| a-5 | ″ | ″ | ″ | ″ | 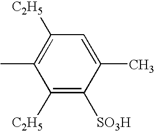 | ″ | ″ | CH₃ | SO₃H | ″ |

″: same as above

TABLE 2

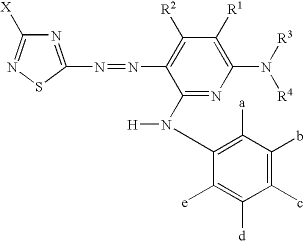

| Com- | | | | | | | | | | |
|---|---|---|---|---|---|---|---|---|---|---|
| pound | X | R¹ | R² | R³ | R⁴ | a | b | c | d | e |
| b-1 | —SCH₃ | CN | CH₃ | H | 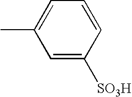 | CH₃ | H | SO₃H | H | C₂H₅ |
| b-2 | 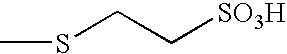 | CONH₂ | H | ″ | 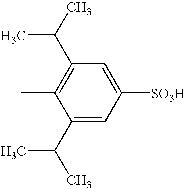 | iPr | ″ | ″ | ″ | iPr |
| b-3 | 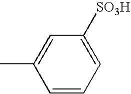 | H | CH₃ | 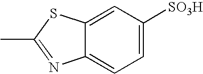 | ″ | ″ | ″ | ″ | ″ | ″ |
| b-4 | 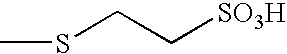 | ″ | ″ | ″ | 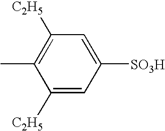 | C₂H₅ | ″ | ″ | ″ | C₂H₅ |
| b-5 | —SCH₃ | ″ | ″ | ″ | 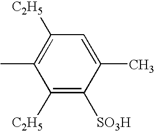 | ″ | ″ | CH₃ | SO₃H | ″ |

″: same as above

TABLE 3

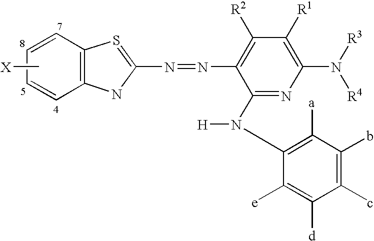

| Compound | X | R¹ | R² | R³ | R⁴ | a | b | c | d | e |
|---|---|---|---|---|---|---|---|---|---|---|
| c-1 | 5-Cl | CN | CH₃ | H | 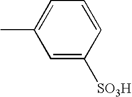 | CH₃ | H | SO₃H | H | C₂H₅ |
| c-2 | 5,6-diCl | CONH₂ | H | ″ | 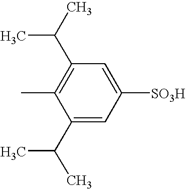 | iPr | ″ | ″ | ″ | iPr |
| c-3 | 5-CH₃ | H | CH₃ | 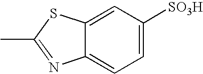 | ″ | ″ | ″ | ″ | ″ | ″ |
| c-4 | 6-Cl | ″ | ″ | ″ | 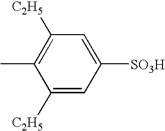 | C₂H₅ | ″ | ″ | ″ | C₂H₅ |
| c-5 | 5,6-diCl | ″ | ″ | ″ | 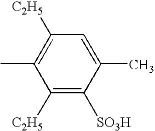 | ″ | ″ | CH₃ | SO₃H | ″ |

″: same as above

TABLE 4

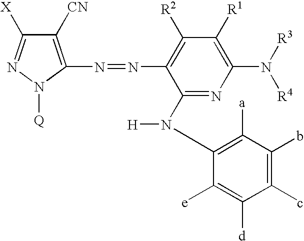

| Com- | | | | | | | | | | | |
|---|---|---|---|---|---|---|---|---|---|---|---|
| pound | X | Q | R¹ | R² | R³ | R⁴ | a | b | c | d | e |
| d-1 | 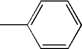 | 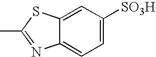 | CN | CH₃ | H | 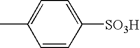 | CH₃ | H | SO₃H | H | C₂H₅ |
| d-2 | t-Bu | ″ | CONH₂ | H | ″ | 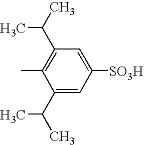 | iPr | ″ | ″ | ″ | iPr |
| d-3 | ″ | ″ | H | CH₃ | 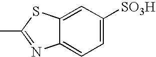 | ″ | ″ | ″ | ″ | ″ | ″ |
| d-4 | ″ | ″ | ″ | ″ | ″ | 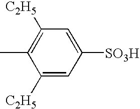 | C₂H₅ | ″ | ″ | ″ | C₂H₅ |
| d-5 | ″ | ″ | ″ | ″ | ″ | 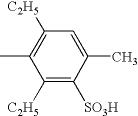 | ″ | ″ | CH₃ | SO₃H | ″ |

″: same as above

TABLE 5

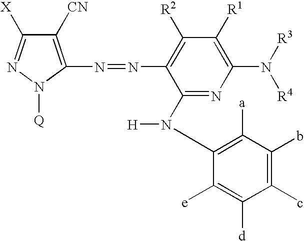

| Com- | | | | | | | | | | | |
|---|---|---|---|---|---|---|---|---|---|---|---|
| pound | X | Q | R¹ | R² | R³ | R⁴ | a | b | c | d | e |
| d-6 | t-Bu | 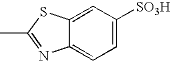 | H | CH₃ | 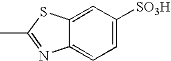 | 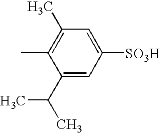 | CH₃ | H | SO₃H | H | iPr |
| d-7 | ″ | ″ | ″ | ″ | ″ | 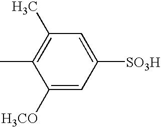 | ″ | ″ | ″ | ″ | OCH₃ |
| d-8 | ″ | ″ | ″ | ″ | ″ | 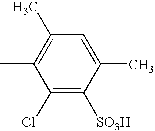 | ″ | ″ | CH₃ | SO₃H | Cl |
| d-9 | ″ | 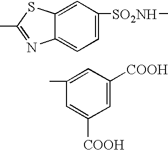 | ″ | ″ | 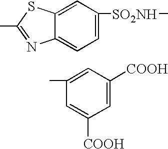 | 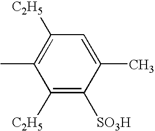 | C₂H₅ | ″ | ″ | ″ | C₂H₅ |
| d-10 | ″ | ″ | ″ | ″ | ″ | 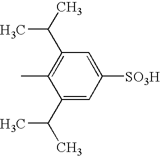 | iPr | ″ | SO₃H | ″ | iPr |

″: same as above

TABLE 6

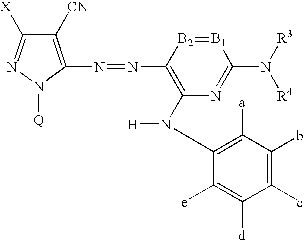

| Com- | | | | | | | | | | |
|---|---|---|---|---|---|---|---|---|---|---|
| pound | Q | B₁ | B₂ | R³ | R⁴ | a | b | c | d | e |
| d-11 | 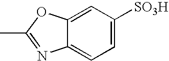 | N | C—CH₃ | H | 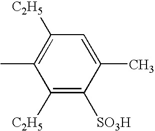 | C₂H₅ | H | CH₃ | SO₃H | C₂H₅ |
| d-12 | 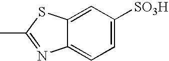 | ″ | 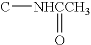 | ″ | ″ | ″ | ″ | ″ | ″ | ″ |
| d-13 | ″ | C—H | N | ″ | 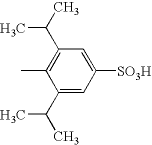 | iPr | ″ | SO₃H | H | iPr |
| d-14 | 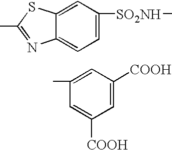 | C—H | N | 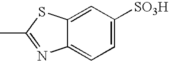 | 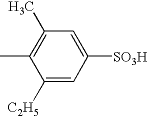 | CH₃ | ″ | ″ | ″ | C₂H₅ |
| d-15 | ″ | N | 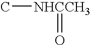 | ″ | ″ | ″ | ″ | ″ | ″ | ″ |

″: same as above

100 parts by mass of the ink in the invention contains preferably 0.1 parts by mass to 20 parts by mass, more preferably 0.2 parts by mass to 10 parts by mass, and further preferably 0.5 to 9 parts by mass of the dye represented by the above-described formula (1).

When the content of the above-described dye is less than 0.1 parts by mass, sufficient image fastness may not be achieved, and when the content exceeds 20 parts by mass, ink stability and ejection stability may be poor.

The ink jet ink in the invention may contain, in addition to the above-described compound (dye) according to the invention, a known dye, as long as it does not impair the effect of the invention. In this case, the proportion of the known dye(s) relative to the compound represented by formula (1) is not particularly limited, and may be any proportions.

In the ink in the invention, the dye represented by the above-described formula (1) may be used alone or in combination in plurality. When two or more kinds of dyes are used in combination, the total content of the dye is preferably within the above-described range of the amount of the dye to be added.

The azo dye represented by the above-described formula (1) used in the ink in the invention is a novel compound. Examples of the application of such a dye include an image recording material for forming an image, specifically a color image, typified by the ink in the invention, and specific examples thereof include an ink jet recording material which will be described later in detail, and a heat-sensitive recording material, a pressure sensitive recording material, a recording material utilizing an electrophotographic method, a transfer silver halide photosensitive material, a printing ink, and a recording pen. Among these examples, an ink jet recording material, a heat-sensitive recording material, and a recording material utilizing an ectrophotographic method are preferable, and an ink jet recording material is more preferable.

It is also applicable to a color filter for recording/reproducing a color image used in a solid-state image pick-up device such as CCD and a display such as LCD or PDP, and a stain solution for staining various types of fiber.

It is possible to adjust the physical properties of the dye represented by the above-described formula (1) such as solubility, dispersibility, and heat transfer property by using the substituent according to the intended use. The dye of the invention and others can be used in a state of solution, emulsion dispersion, and solid dispersion according to the intended method.

Ink Components Other than the Dye Represented by Formula (I)

The ink in the invention contains the dye represented by the above-described formula (1), and may further contain a medium.

The ink in the invention can be prepared by dissolving and/or dispersing the above-described dye in a lipophilic medium or an aqueous medium used as a medium. It is preferable to use an aqueous medium. The ink in the invention also includes an ink composition which does not include the medium.

If necessary, the ink in the invention may contain other additives within the range which does not impair the effect of the invention.

Examples of the other additives include known additives such as an antidrying agent (wetting agent), an fading-preventing agent, an emulsification stabilizing agent, a penetration enhancing agent, an ultraviolet absorbing agent, a preservative, an anti-fungus agent, a pH-adjusting agent, a surface tension controlling agent, an antifoaming agent, a viscosity controlling agent, a dispersant, a dispersion stabilizing agent, a rust preventive agent, and a chelating agent.

When the ink is water-soluble, these various additives are directly added to the ink liquid.

When an oil-soluble dye is used in a state of dispersion, it is common to add the oil-soluble dye to a prepared dye dispersion, however the oil-soluble dye may be added to an oil phase or an aqueous phase during preparation.

The antidrying agent is preferably used for preventing clogging due to drying of the ink jet ink at the ink jetting port of a nozzle used for the inkjet recording method.

As the antidrying agent, a water-soluble organic solvent having a vapor pressure lower than that of water is preferable. Specific examples include polyhydric alcohols such as ethylene glycol, propylene glycol, diethylene glycol, triethylene glycol, polyethylene glycol, thiodiglycol, dithiodiglycol, 2-methyl-1,3-propanediol, 1,2,6-hexanetriol, acetylene glycol derivatives, glycerol, and trimethylol propane; lower alkyl ethers of polyhydric alcohols such as ethylene glycol monomethyl (or ethyl)ether, diethylene glycol monomethyl (or ethyl)ether, and triethylene glycol monoethyl (or butyl)ether; heterocycles such as 2-pyrrolidone, N-methyl-2-pyrrolidone, 1,3-dimethyl-2-imidazolidinone, and N-ethyl morpholine; sulfur-containing compounds such as sulfolane, dimethyl sulfoxide, 3-sulfolene; multifunctional compounds such as diacetone alcohol and diethanolamine; and urea derivatives. Among these compounds, polyhydric alcohols such as glycerol, diethylene glycol, and triethylene glycol are more preferable. The above-described antidrying agents may be used alone or in combination of two or more of them. The content of the antidrying agent included in the ink is preferably 10 to 50% by mass.

The penetration enhancing agent is preferably used for the purpose of enhancing penetration of the ink jet recording ink into paper. As the penetration enhancing agent, alcohols such as ethanol, isopropanol, butanol, di(tri)ethylene glycol monobutyl ether, and 1,2-hexanediol, sodium lauryl sulfate, sodium oleate, a nonionic surfactant or the like can be used. The penetration enhancing agent usually achieves sufficient effect when it is contained in the ink in an amount of 5 to 30% by mass, and is preferably added within the range which does not cause bleeding of printing and print through.

The ultraviolet absorbing agent is used for the purpose of improving the storability of an image. Examples of the ultraviolet absorbing agent which can be used include the benzotriazole-based compounds described in JP-A Nos. 58-185677, 61-190537, 2-782, 5-197075, 9-34057 and others, the benzophenone-based compounds described in JP-A Nos. 46-2784 and 5-194483, U.S. Pat. No. 3,214,463 and others, the cinnamic acid-based compounds described in Japanese Patent Application Publication (JP-B) Nos. 48-30492 and 56-21141, JP-A No. 10-88106 and others, the triazine-based compounds described in JP-A Nos. 4-298503, 8-53427, 8-239368, 10-182621, Japanese Patent Application National Publication (Laid-Open) No. 8-501291 and others, the compounds described in Research Disclosure No. 24239, a compound which absorbs ultraviolet ray to generate fluorescence, such as a stilbene-based compound and a benzoxazole-based compound, and a so-called fluorescent whitening agent.

The fading-preventing agent may be used for the purpose of improving the storability of an image. As the fading-preventing agent, various types of organic-based and metal complex-based fading-preventing agents can be used. Examples of the organic fading-preventing agent include hydroquinones, alkoxy phenols, dialkoxy phenols, phenols, anilines, amines, indanes, chromanes, alkoxy anilines, and heterocycles, and examples of the metal complex include a nickel complex and a zinc complex. More specifically, the compounds described in the patents cited in Research Disclosure No. 17643, VII, Sections I through J, No. 15162, No. 18716, pp. 650, the left column, No. 36544, pp. 527, No. 307105, pp. 872, and No. 15162, and the compounds represented by the formulae of typical compounds and included in the examples of compounds described in JP-A No. 62-215272, pp. 127-137 can be used.

Examples of the anti-fungus agent include sodium dehydroacetate, sodium benzoate, sodium pyridinethione-1-oxide, p-hydroxy benzoate ethyl ester, 1,2-benzisothiazoline-3-on, and salts thereof. The content of the anti-fungus agent in the ink is preferably 0.02 to 1.00% by mass.

As the pH-adjusting agent, the neutralizing agent (an organic base and an inorganic alkali) can be used. The pH-adjusting agent is added for the purpose of improving the storage stability of the ink jet ink, and added in a manner that the pH of the ink jet ink is preferably 6 to 10, and more preferably 7 to 10.

Examples of the above-described surface tension controlling agent include a nonionic, cationic, or anionic surfactant. The surface tension or the ink jet ink of the invention is preferably 20 to 60 mN/m, and more preferably 25 to 45 mN/m. The viscosity of the ink jet ink of the invention is preferably 30 mPa·s or less, and more preferably adjusted to 20 mPa·s or less. Preferable examples of the surfactant include anionic surfactants such as a fatty acid salt, an alkylsulfuric acid ester salt, an alkylbenzene sulfonate, an alkylnaphthalene sulfonate, a dialkylsulfosuccinic acid salt, an alkylphosphoric acid ester salt, a naphthalenesulfonic acid formalin condensate, a polyoxyethylenealkylsulfuric acid ester salt, and nonionic surfactants such as a polyoxyethylenealkyl ether, a polyoxyethylenealkylallyl ether, a polyoxyethylene fatty acid ester, a sorbitan fatty acid ester, a polyoxyethylene sorbitan fatty acid ester, a polyoxyethylene alkylamine, a glycerol fatty acid ester, and an oxyethyleneoxypropylene block copolymer. SURFYNOLS (trade name, manufactured by AirProducts & Chemicals), which is an acetylene-based polyoxyethylene oxide surfactant, is also preferably used. Ampholytic surfactants of amine oxide type such as N,N-dimethyl-N-alkylamine oxide are also preferable. Furthermore, those listed as surfactants described in JP-A No. 59-157636, pp. (37) to (38), Research Disclosure No. 308119 (1989) can be also used.

As the antifoaming agent, fluorine-based or silicone-based compounds and chelating agents such as EDTA can be used as necessary.

When the ink in the invention is prepared by dispersing the dye represented by the above-described formula (1) in an aqueous medium, it is preferable to disperse a colored fine particles containing a dye and an oil-soluble polymer in an aqueous medium described in JP-A No. 11-286637, and Japanese Patent Application Nos. 2000-78491, 2000-80259, and 2000-62370, or disperse a high boiling point organic solvent solution of a dye represented by the above-described formula (1), typified by the dye of the invention, in an aqueous medium described in Japanese Patent Application Nos. 2000-78454, 2000-78491, 2000-203856, and 2000-203857. As the specific method of dispersing the dye of the invention in an aqueous medium, and the oil-soluble polymer, the high boiling point organic solvent, and the additive to be used and the amount used thereof, those described in the above-described descriptions can be preferably used.

Alternatively, in an embodiment, the dye represented by formula (1) in a solid form may be dispersed to form fine particles.

A dispersant and a surfactant may be used in dispersing. As the dispersing apparatus, a simple stirrer, an impeller stirring method, an inline stirring method, a mill method (e.g., colloid mill, ball mill, sand mill, attritor, roll mill, and agitator mill), an ultrasonic method, a high pressure emulsification method (high pressure homogenizer; specific examples of commercial apparatus include a Gaulin homogenizer, a microfluidizer, and DeBEE 2000) can be used.

The method for preparing the ink jet recording ink is described in detail, in addition to the aforementioned patents, in JP-A Nos. 5-148436, 5-295312, 7-97541, 7-82515, 7-118584, 11-286637, and Japanese Patent Application No. 2000-87539. These methods can be used for the preparation of the ink jet recording ink in the invention.

The above-described aqueous medium may include water as a main component, and if desired, a mixture of water and a water miscible organic solvent can be used as the medium. Examples of the water miscible organic solvent include alcohols (e.g., methanol, ethanol, propanol, isopropanol, butanol, isobutanol, sec-butanol, t-butanol, pentanol, hexanol, cyclohexanol, and benzyl alcohol), polyhydric alcohols (e.g., ethylene glycol, diethylene glycol, triethylene glycol, polyethylene glycol, propylene glycol, dipropylene glycol, polypropylene glycol, butylene glycol, hexanediol, pentanediol, glycerol, hexanetriol, and thiodiglycol), glycol derivatives (e.g., ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, and ethylene glycol monophenyl ether), amines (e.g., ethanolamine, diethanolamine, triethanolamine, N-methyl diethanolamine, N-ethyl diethanolamine, morpholine, N-ethyl morpholine, ethylene diamine, diethylene triamine, triethylene tetramine, polyethylene imine, and tetra methylpropylene diamine) and other polar solvents (e.g., formamide, N,N-dimethylformamide, N,N-dimethyl acetamide, dimethyl sulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, and acetone). The water miscible organic solvents may be used in combination of two or more of them.

The ink jet recording ink in the invention can be used not only for forming a monochromatic image, but also for forming a full color image. For forming a full color image, a magenta color tone ink, a cyan color tone ink, and a yellow color tone ink may be used. Also, for adjusting the color tone, a black color tone ink may be further used.

In the ink jet recoding ink in the invention, the above-described dye in the invention can be used together with other dyes, for example, a yellow dye, a magenta dye, a cyan dye or a black colorant. As the applicable yellow dye, any dye can be used. Examples thereof include aryl or heteryl azo dyes including a phenol, a naphthol, an aniline, a heterocycle such as pyrazolone or pyridone, an open-chain active methylene compound, or the like as the coupling component (hereinafter referred to as a coupler component); azo methine dyes including an open-chain active methylene compound or the like as the coupler component; methine dyes such as a benzylidene dye and a monomethine oxonol dye; quinone-based dyes such as a naphthoquinone dye and an anthraquinone dye. Examples of the other types of dyes include a quinophthalone dye, a nitro/nitroso dye, an acridine dye, and an acridinon dye.

As the applicable magenta dye, any dye can be used. Examples thereof include aryl or heteryl azo dyes including a phenol, naphthol, aniline, or the like as the coupler component; azo methine dyes including a pyrazolone, pyrazolotriazole, or the like as the coupler component; methine dyes such as an arylidene dye, a styryl dye, a melocyanine dye, a cyanine dye, and an oxonol dye; carbonium dyes such as a diphenyl methane dye, a triphenylmethane dye, and a xanthene dye; quinone dyes such as naphthoquinone, anthraquinone, and anthrapyridone; and condensed polycyclic dyes such as a dioxazine dye.

As the applicable cyan dye, any dye can be used. Examples thereof include aryl or heteryl azo dyes including a phenol, a naphthol, an anilines, or the like as the coupler component; azo methine dyes including a phenol, a naphthol, a heterocycle such as pyrrolotriazole, or the like as the coupler component; polymethine dyes such as a cyanine dye, an oxonol dye, and a melocyanine dye; carbonium dyes such as a diphenyl methane dye, a triphenylmethane dye, and a xanthene dye; a phthalocyanine dye; an anthraquinone dye; and an indigo/thioindigo dye.

The above-described dyes may develop a yellow, magenta, or cyan color only after a part of the chromophore causes dissociation, and in this case, the counter cation may be an inorganic cation such as alkali metal and ammonium, an organic cation such as pyridinium and quaternary ammonium salt, or a polymer cation including the above-described cations in its partial structure.

Examples of the applicable black colorant include disazo, trisazo, and tetraazo dyes, and dispersed carbon black.

Inkjet Recording Medium

Next, the ink jet recording medium in the invention is described in more detail.

The ink jet recording medium in the invention includes a water-soluble aluminum compound and a sulfoxide compound in an ink-receiving layer on a support.

The ink jet recording medium in the invention comprises a sulfoxide compound and a water-soluble aluminum compound in the ink-receiving layer, Therefore, it is possible to obtain a favorable ink absorptive property and glossiness, and sufficiently prevent the bleeding of the recorded image for a long period. Furthermore, it is possible to remarkably improve the light resistance and ozone resistance of the image by using the medium in combination with the ink in the invention.

The structure of ink jet recording medium in the invention is described in more detail below.

Ink-Receiving Layer

As described above, the ink-receiving layer includes at least one sulfoxide compound and at least one water-soluble aluminum compound.

Sulfoxide Compound

The above-described sulfoxide compound preferably includes, in its molecule, one or more structures represented by the following formula (S1).

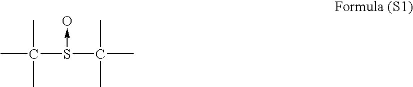

The sulfoxide compound including the structure represented by formula (S1) may be substituted by a hydrophilic group. Examples of the hydrophilic group include a substituted or unsubstituted amino group, a substituted or unsubstituted carbamoyl group, a substituted or unsubstituted sulfamoyl group, a substituted or unsubstituted ammonium, a hydroxyl group, a sulfonic acid, a carboxylic acid, a phosphoric acid, an ethyleneoxy acid, a substituted or unsubstituted nitrogen-containing heterocycle.

Furthermore, the above-described sulfoxide compound is preferably a compound represented by the following formula (S2).

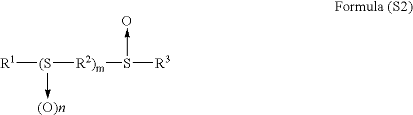

In formula (S2), R¹ and R³ each independently represent a substituted or unsubstituted alkyl group, a substituted or unsubstituted aryl group, a substituted or unsubstituted heterocyclic group, or a polymer residue including any one of them. R¹ and R³ may be the same or different, and may be bonded to each other to form a ring. R² represents a substituted or unsubstituted linking group having a valence of 2 to 6, R¹ and R² may be bonded to each other to form a ring, R² and R³ may be bonded to each other to form a ring. m represents an integer of 0 or 1 or more, and n represents 0 or 1. At least one of R¹, R², and R³ represents an alkyl group substituted by a hydrophilic group, an aryl group substituted by a hydrophilic group, a heterocyclic group substituted by a hydrophilic group, or a polymer residue substituted by a hydrophilic group, wherein the hydrophilic group is represented by a substituted or unsubstituted amino group, a substituted or unsubstituted carbamoyl group, a substituted or unsubstituted sulfamoyl group, a substituted or unsubstituted ammonium, a hydroxyl group, a sulfonic acid, a carboxylic acid, a phosphoric acid, an ethyleneoxy group, or a substituted or unsubstituted nitrogen-containing heterocycle.

In formula (S2), the unsubstituted alkyl group represented by R¹ and R³ may have a straight chain, branched, or cyclic structure, and may have unsaturated bond(s), for example, preferably an alkyl group having 1 to 22 carbon atoms. Specific examples thereof include a methyl group, an ethyl group, an allyl group, a N-butyl group, a N-hexyl group, a N-octyl group, a benzyl group, an iso-propyl group, an iso-butyl group, a sec-butyl group, a cyclohexyl group, and a 2-ethylhexyl group, among these groups, an alkyl group having 1 to 10 carbon atoms is more preferable, and a methyl group, an ethyl group, an allyl group, a N-propyl group, an iso-butyl group, a cyclohexyl group, and a 2-ethylhexyl group are particularly preferable.

As the unsubstituted aryl group represented by Rland R³, an aryl group having 6 to 22 carbon atoms is preferable. Specific examples thereof include a phenyl group, a 1-naphthyl group, and a 2-naphthyl group. Among them, a phenyl group is particularly preferable.

Examples of the unsubstituted heterocyclic group represented by R¹ and R³ include an thienyl group, a thiazolyl group, an oxazolyl group, a pyridyl group, a pyrazyl group, a thiadiazoyl group, a triazoyl group, a morphoryl group, a piperazyl group, a pyrimidyl group, a triazyl group, an indolyl group, a benzothiazoyl group, and a benzooxazoyl group. Among them, a thiazolyl group, an oxazoyl group, a pyridyl group, a thiadiazoyl group, a triazoyl group, morphoryl group, a pyrimidyl group, a triazyl group, a benzothiazoyl group, and a benzooxazoyl group are particularly preferable.

When R¹ and/or R³ represent a polymer residue including a substituted or unsubstituted alkyl group, aryl group, or heterocycle residue, examples of the polymer residue include polymers having the following units.

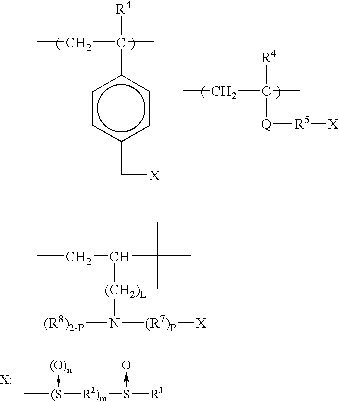

In the above units, R⁴ represents a hydrogen atom or an alkyl group having 1 to 4 carbon atoms, R⁵ represents an alkylene group, and Q represents a linking group. R⁷ and R⁸ represent an alkylene group, L represents 1 or 2, and P represents 1 or 2. R², R³, m, and n have the same definitions as R², R³, m, and n in the above-described formula (S2).

In the above unit, examples of the linking group represented by Q include the following linking groups.

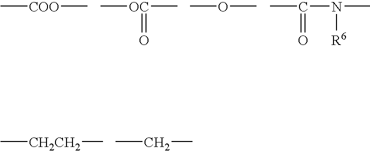

In the above liking groups, R⁶ represents a hydrogen atom, an alkyl group, or an aryl group.

When R¹ and/or R³ represent an alkyl group, an aryl group, or a heterocycle residue, examples of the substituent include a substituted or unsubstituted amino group (e.g., an amino group having 30 or less carbon atoms, an amino group, an alkylamino group, a dialkylamino group, an arylamino group, and an acylamino group), a substituted or unsubstituted carbamoyl group (e.g., a carbamoyl group having 30 or less carbon atoms, a carbamoyl group, a methylcarbamoyl group, a dimethylcarbamoyl group, a morpholinocarbamoyl group, and a piperidinocarbamoyl group), a substituted or unsubstituted ammonium (e.g., ammonium having 30 or less carbon atoms, ammonium, trimethylammonium, triethylammonium, dimethylbenzyl ammonium, and hydroxyethyl dimethylammonium), a substituted or unsubstituted sulfamoyl group (e.g., a sulfamoyl group having 30 or less carbon atoms, a sulfamoyl group, a methylsulfamoyl group, a dimethylsulfamoyl group, a morpholinosulfamoyl group, and a piperidinosulfamoyl group), a substituted or unsubstituted nitrogen-containing heterocycle (e.g., a pyridyl group, a pyrimidyl group, a morpholino group, a pyrrolidino group, a piperidino group, and a piperazyl group), a hydrophilic group represented by a hydroxyl group, a sulfonic acid, a carboxylic acid, a phosphoric acid, an ethyleneoxy group, or the like, a cyano group, a halogen atom (e.g., a fluorine atom, a chlorine atom, and a bromine atom), a substituted or unsubstituted alkoxycarbonyl group (e.g., an alkoxycarbonyl group having 30 or less carbon atoms, a methoxycarbonyl group, an ethoxycarbonyl group, a dimethylaminoethoxyethoxycarbonyl group, a diethylaminoethoxycarbonyl group, a hydroxyethoxycarbonyl group), a substituted or unsubstituted aryloxycarbonyl group (e.g., an aryloxycarbonyl group having 30 or less carbon atoms, and a phenoxycarbonyl group), a substituted or unsubstituted alkoxy group (e.g., an alkoxy group having 30 or less carbon atoms, a methoxy group, an ethoxy group, a phenoxyethoxy group, a butoxyethoxy group, a hydroxyethoxy group), a substituted or unsubstituted aryloxy group (e.g., an aryloxy group having 30 or less carbon atoms, and a phenoxy group), a substituted or unsubstituted acyloxy group (e.g., an acyloxy group having 30 or less carbon atoms, an acetyloxy group, and a propionyloxy group), a substituted or unsubstituted acyl group (e.g., an acyl group having 30 or less carbon atoms, an acetyl group, and a propionyl group).

R¹ and R³ may be the same or different, and may be bonded to each other to form a ring.

R² represents a substituted or unsubstituted linking group having a valence of 2 to 6. R¹ and R² may be bonded to each other to form a ring. R² and R³ may be bonded to each other to form a ring. Examples of the sulfur heterocycle formed by the linking between R¹ and R², R¹ and R³, or R¹ and R³ include a thienyl group, a thiazoyl group, a thiazolidyl group, a dithiolane-2-yl group, a trithiane-2-yl group, and a dithiane-2-yl group.

The linking group having a valence of 2 to 6 represented by R² may be a linking group containing carbon, nitrogen, oxygen, or phosphorus, and specific examples thereof include the following linking groups.

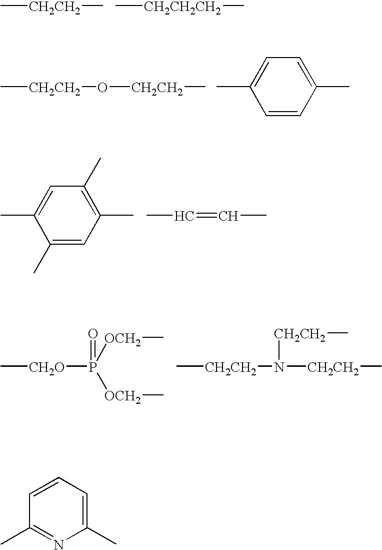

These linking groups may contain a hetero bond such as an ether bond, an ester bond, an amino bond, an amide bond, and an urethane bond, and may have another substituent. A polymer in which the linking group is repeated may be used as a linking group. In such cases, the linking group included in the polymer may be the same or different.

At least one of R¹, R², and R³ represents an alkyl group substituted by a hydrophilic group, an aryl group substituted by a hydrophilic group, a heterocyclic group substituted by a hydrophilic group, or a polymer residue substituted by a hydrophilic group, wherein the hydrophilic group is represented by a substituted or unsubstituted amino group, a substituted or unsubstituted carbamoyl group, a substituted or unsubstituted sulfamoyl group, a substituted or unsubstituted ammonium, a hydroxyl group, a sulfonic acid, a carboxylic acid, a phosphoric acid, an ethyleneoxy group, or a substituted or unsubstituted nitrogen-containing heterocycle. Examples of these hydrophilic groups include the substituents listed for the above-described R¹ and R³.

Substantially water-based coating is used in the ink jet recording medium in the invention, therefore the sulfoxide compound is preferably water-soluble.

Furthermore, as the sulfoxide compound is a Lewis base, it has higher water solubility and can be added in a larger amount than a thioether compound.

When the sulfoxide compound according to the invention is water-soluble, the sulfoxide compound is preferably added to the coating liquid containing fine particles and a water-soluble resin or a basic solution which will be described later.

Furthermore, when the sulfoxide compound according to the invention is oil-soluble, it is preferable to add an emulsion dispersion of the sulfoxide compound or a solution of the sulfoxide compound in an organic solvent to the coating liquid containing fine particles and a water-soluble resin or the basic solution.

In the ink jet recording medium in the invention, the content of the above-described sulfoxide compound is preferably 0.01 to 20 g/m², and more preferably 0.05 to 7 g/m² for further improving ozone resistance, image bleeding resistance, and glossiness.

In the ink jet recording medium in the invention, the above-described sulfoxide compound has a higher oxidation potential than conventional sulfur-containing compounds (thioethers and thioureas), thus it can exhibit higher resistance against ozone and light by combining with a dye having a high oxidation potential which can advantageously improves ozone and light resistance.

The sulfoxide compound may be used alone or in combination of two or more of them.

Specific examples of the sulfoxide compound are shown below (exemplary compounds A-1 to A-75), however the invention is not limited to them.

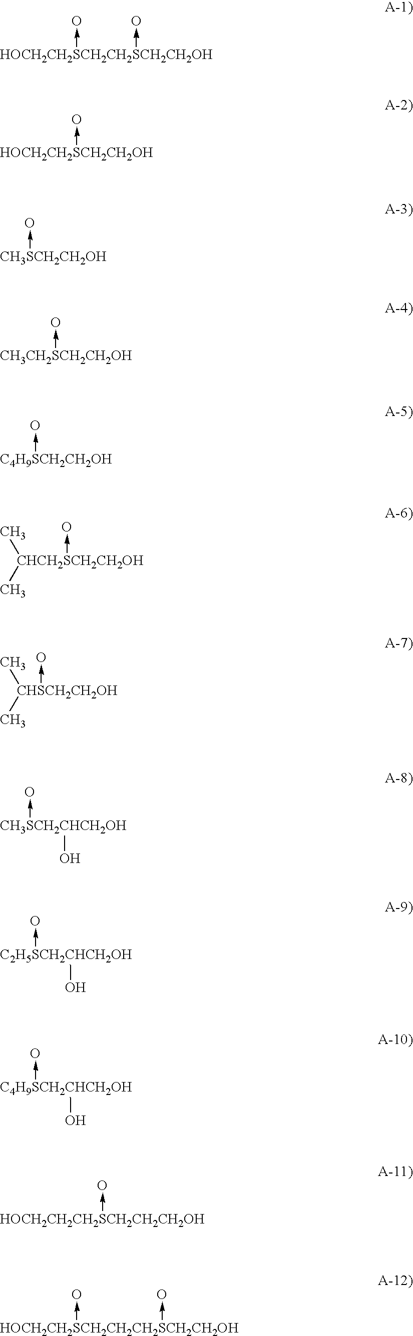

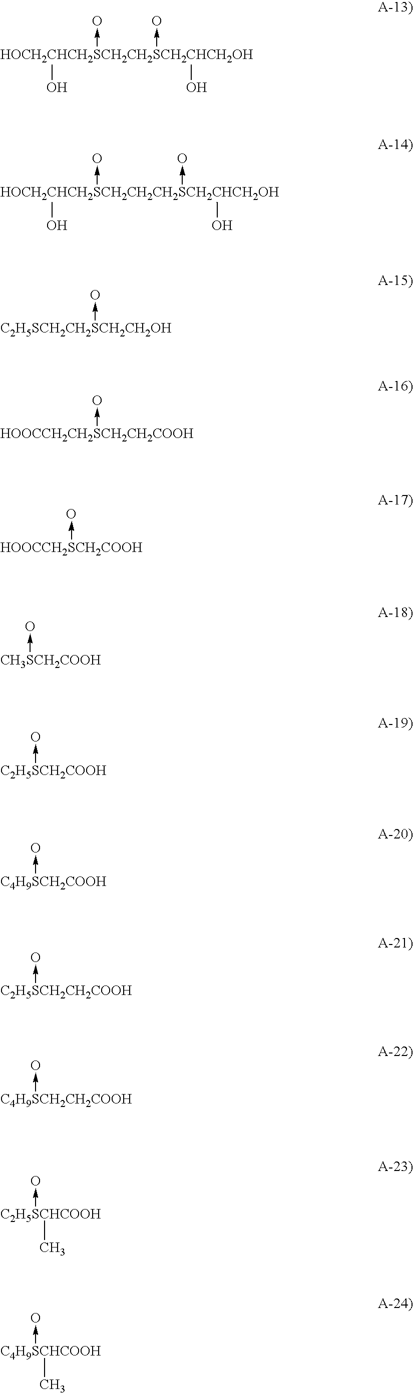

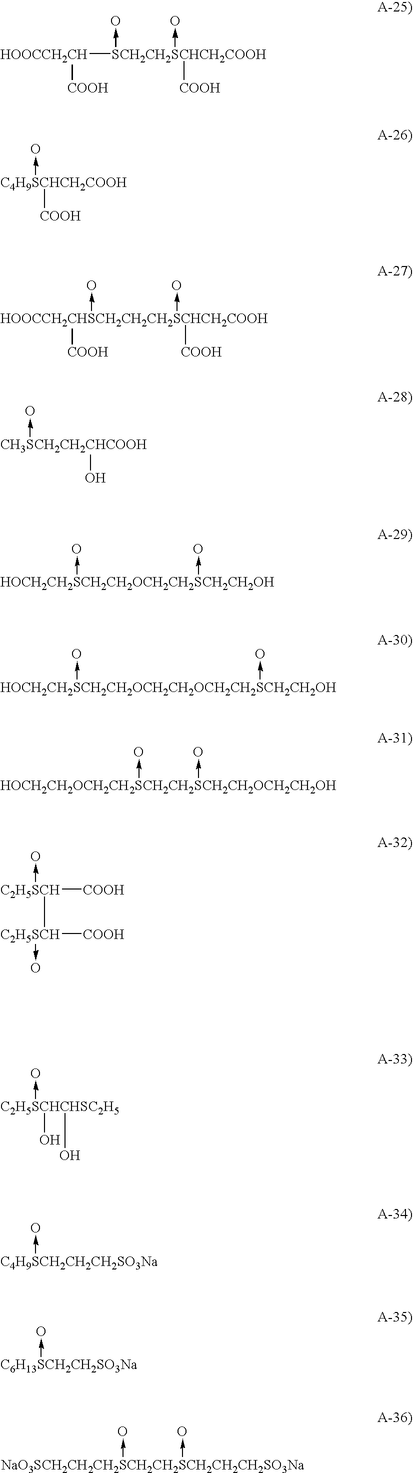

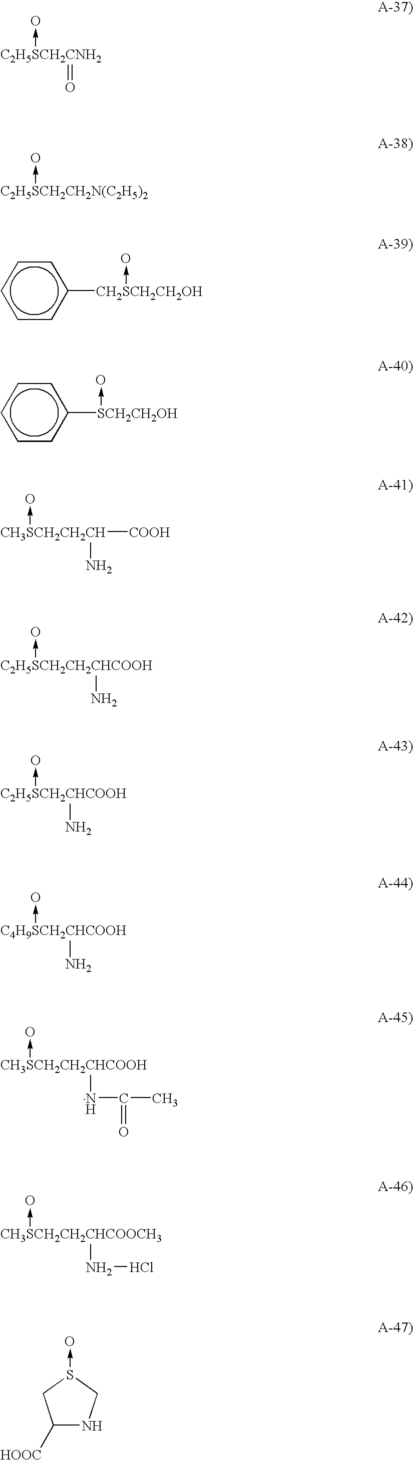

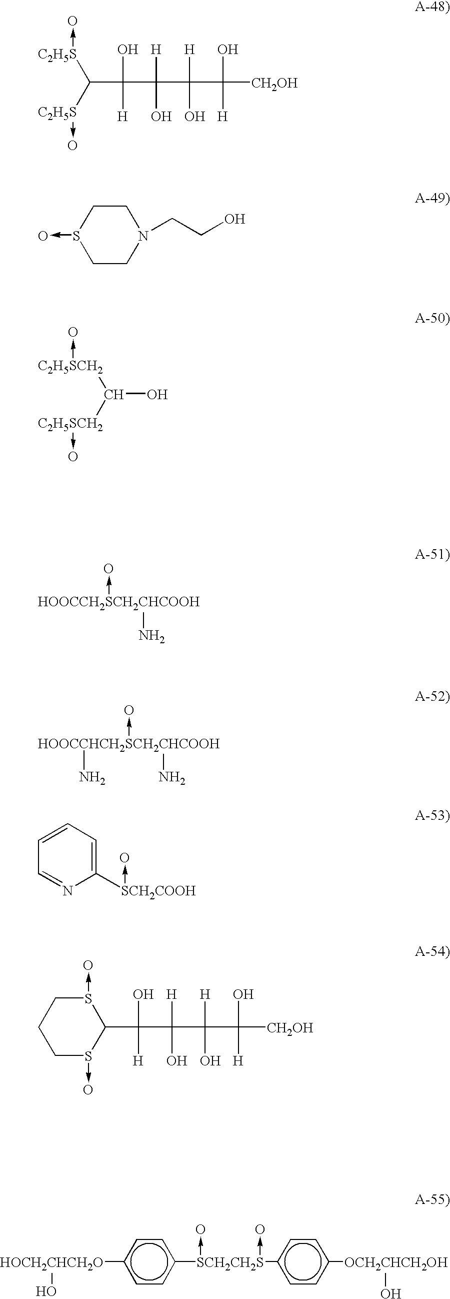

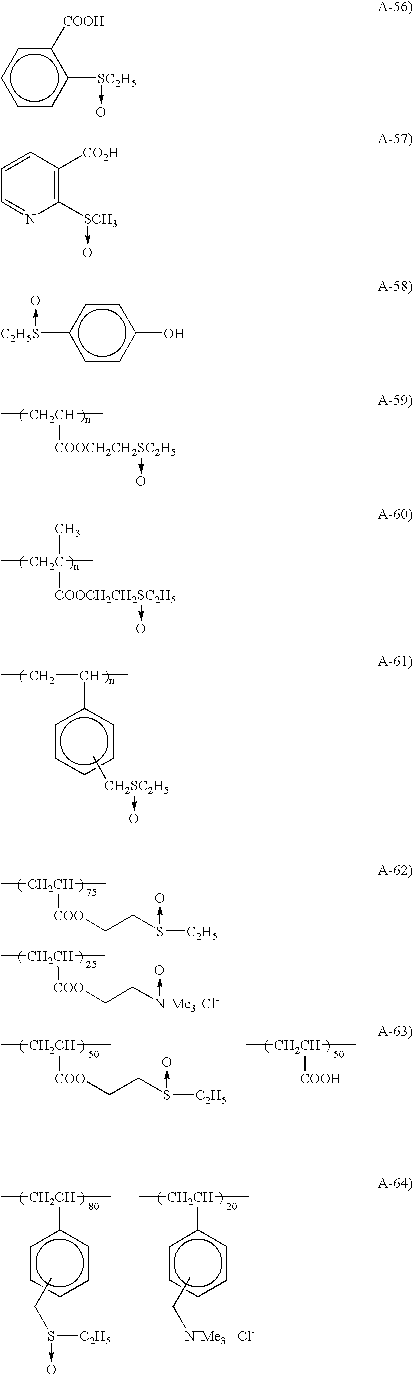

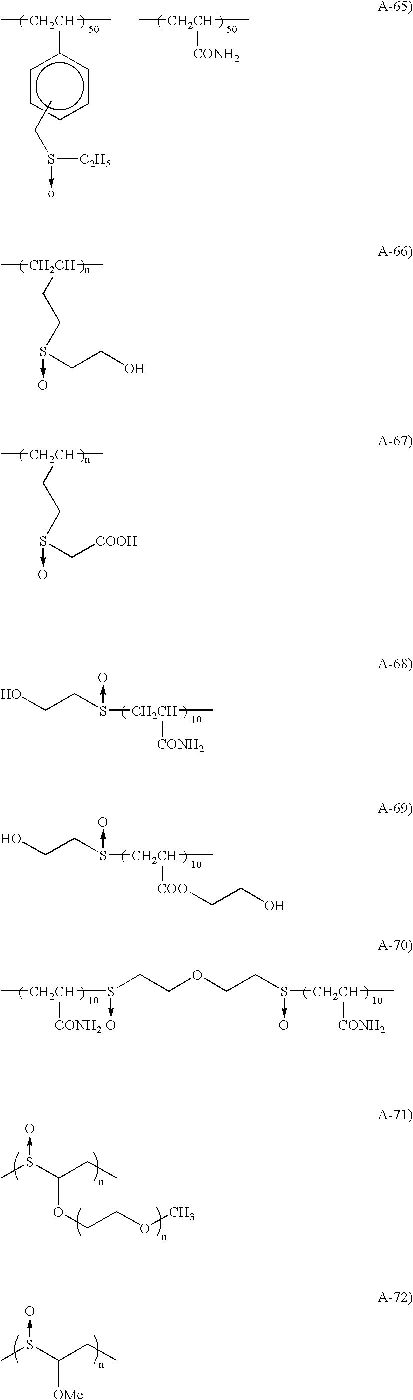

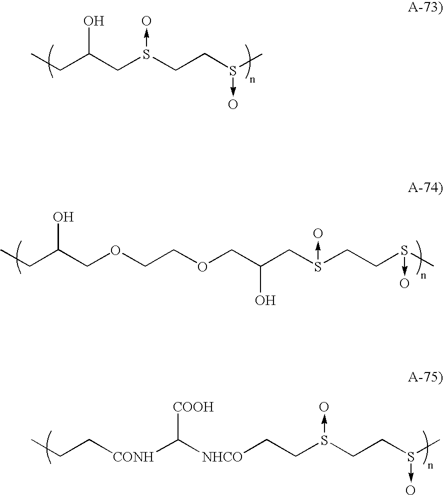

Water-Soluble Aluminum Compound

Next, the water-soluble aluminum compound is described in more detail. Specific examples of the water-soluble aluminum compound used in combination with the sulfoxide compound include followings:

Aluminum-containing compounds such as aluminum sulfate, aluminum alum, aluminum sulfite, aluminum thiosulfate, polyaluminum chloride, aluminum nitrate nonahydrate, and aluminum chloride hexahydrate. Among them, polyaluminum chloride is preferable.

The polyaluminum chloride is a water-soluble poly aluminum hydroxide including the main component represented by the following formula 1, 2, or 3, and stably containing a basic polymer polynuclear condensed ion such as [Al₆(OH)₁₅]³⁺, [Al₈(OH)₂₀]⁴⁺[Al₁₃(OH)₃₄]⁵⁺, and [Al₂₁(OH)₆₀]³⁺.

[Al₂(OH)ₙCl₆₋ₙ]ₘ Formula 1

[Al(OH)₃]nAlCl₃ Formula 2

[Al(OH)ₘC1₍₃ₙ₋ₘ₎ Formula 3

In formulae 1 to 3, 0≦m≦3n.

These compounds are supplied from Taki Chemical Co., Ltd. under the name of poly aluminum chloride (PAC) as a chemical for water treatment, from Asada Chemical Industry Co., Ltd. under the name of poly aluminum hydroxide (Paho), from Riken Green Co., Ltd. under the name of under the name of PURACHEM WT, from Taimei Chemicals Co., Ltd. under the name of ALUFINE 83, and from other manufacturers for the same purpose. Products of various grades are easily available. In the invention it is possible to use any of such commercially available products as it is, but since there are materials which have inappropriately low pH values, in these cases it is possible to use by suitably adjusting the pH.

In the ink jet recording medium in the invention, the content of the above-described water-soluble aluminum compound is preferably higher for further improving ozone resistance, image bleeding resistance, and glossiness, and preferably 0.1 to 20 g/m², more preferably, 0.4 to 10 g/m², and further preferably 0.8 to 5 g/m².

If the content of the water-soluble aluminum compound is less than 0.1 g/m², desired ozone resistance may be hardly achieved, image bleeding may occur, and desired glossiness may not be achieved.

If the content exceeds 20 g/m², ink absorption capacity may become insufficient.

The water-soluble aluminum compound according to the invention may be used alone or in combination of two or more of them.

The ink jet recording medium in the invention may contain another water-soluble polyvalent metal salt other than the above-described water-soluble aluminum compound within the range which does not impair the effect of the invention.

Specific examples of the another water-soluble polyvalent metal salt include followings.

Calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, ammonium copper chloride (II) dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amide sulfate tetrahydrate, ferrous bromide, ferrous chloride, ferric chloride, ferrous sulfate, ferric sulfate, zinc phenol sulfonate, zinc bromide, zinc chloride, zinc nitrate hexahydrate, zinc sulfate, titanium tetrachloride, tetraisopropyl titanate, titanium acetyl acetonate, titanium lactate, zirconium acetyl acetonate, zirconyl acetate, zirconyl sulfate, zirconyl ammonium carbonate, zirconium stearate, zirconyl octoate, zirconyl nitrate, zirconium oxychloride, zirconium hydroxychloride, chromium acetate, chromium sulfate, magnesium sulfate, magnesium chloride hexahydrate, magnesium citrate nonahydrate, sodium phosphotungstic acid, sodium citrate tungsten, 12 tungusto phosphoric acid n-hydrate, 12 tungusto silicic acid 26 hydrate, molybdenum chloride, 12 molybdo phosphoric acid n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octoate, praseodymium nitrate, neodymium nitrate, samarium nitrate, europium nitrate, gadolinium nitrate, dysprosium nitrate, erbium nitrate, ytterbium nitrate, hafnium chloride, and bismuth nitrate. The above-described water-soluble polyvalent metal salts may be used alone or in combination of two or more of them.

These water-soluble polyvalent metal salts may be contained within the range of the content of the water-soluble aluminum compound.

Water-Soluble Resin

The ink jet recording medium in the invention preferably contains a water-soluble resin from the viewpoint of the layer strength and ink absorptive property.

Examples of the water-soluble resin which can be used in the invention include polyvinyl alcohol-based resins which include a hydroxy group as a hydrophilic structural unit [e.g., polyvinyl alcohol (PVA), acetoacetyl-modified polyvinyl alcohol, cation modified polyvinyl alcohol, anion modified polyvinyl alcohol, silanol-modified polyvinyl alcohol, and polyvinyl acetal], cellulose-based resins [e.g., methyl cellulose (MC), ethyl cellulose (EC), hydroxyethyl cellulose (HEC), carboxymethyl cellulose (CMC), hydroxypropyl cellulose (HPC), hydroxyethylmethyl cellulose, and hydroxypropylmethyl cellulose], chitins, chitosans, starch, resins having ether bond(s) [e.g., polyethylene oxide (PEO), polypropylene oxide (PPO), polyethylene glycol (PEG), and polyvinyl ether (PVE)], and resins having carbamoyl group(s) [polyacrylamide (PAAM), polyvinylpyrrolidone (PVP), and hydrazide polyacrylate].

Other examples include polyacrylic acid salts having a carboxyl group as a dissociative group, maleic acid resins, alginic acid salts, and gelatins.

Among the above-described water-soluble resins, the water-soluble resin in the invention is preferably polyvinyl alcohol (PVA). The saponification degree of polyvinyl alcohol (PVA) used in the invention is preferably 75 to 95 mol %, more preferably 77 to 90 mol %, and particularly preferably 80 to 90 mol % from the viewpoint of color development density. The polymerization degree of polyvinyl alcohol (PVA) is preferably 1400 to 5000, and more preferably 2300 to 4000 from the viewpoint of achieving a sufficient layer strength. PVA having a polymerization degree of less than 1400 and PVA having a polymerization degree 1400 or more may be used in combination.

The content of the water-soluble resin in the ink-receiving layer is preferably 5 to 40% by mass, and more preferably 10 to 30% by mass relative to the mass of the total solid content in the ink-receiving layer, because a too low content may cause the deterioration of the layer strength and cracking during drying, and an excessive content may cause the clogging of voids by the resin to decrease the void ratio, which results in the deterioration of the ink absorption property.

The fine particles and a water-soluble resin, which are contained in the ink-receiving layer as the main components and which will be described later, each may be of a single material or of a mixture of different materials.

Examples of the above polyvinyl alcohol include not only polyvinyl alcohol (PVA) but also cation-modified polyvinyl alcohol, anion-modified polyvinyl alcohol, silanol-modified polyvinyl alcohol, and other polyvinyl alcohol derivatives. It is possible to use one kind of polyvinyl alcohol on its own or combinations of two or more kinds of polyvinyl alcohols.

The polyvinyl alcohol contains a hydroxyl group as a structural unit. Hydrogen bonding between the hydroxyl groups and the surface silanol groups on silica fine particles allows the silica fine particles to form a three-dimensional network structure having secondary particles as the network chain units. This three-dimensional network structure thus constructed seems to be the cause of easier development of an ink receiving layer having a porous structure having a higher void ratio.

In ink jet recording medium obtained according to the invention, the ink receiving layer having a porous structure obtained in this manner absorbs inks rapidly due to the capillary phenomenon, and provides printed dots superior in circularity without ink bleeding.

Fine Particles

The ink receiving layer of the ink recording medium according to the invention preferably contains fine particles. Examples of fine particles which may be used in the invention include organic fine particles, silica fine particles, aluminum fine particles and pseudo-boehmite type aluminum oxide fine particles, and at lest one kind of these fine particles may be used. As the fine particles used in the invention, silica fine particles, aluminum fine particles and pseudo-boehmite type aluminum oxide fine particles are preferable.

The average primary particles size of the fine particles of the present invention is preferably 50 nm or less, more preferably 30 nm or less, and particularly preferably 15 nm or less. When the average primary particle size of the particles is 15 nm or less, the ink-absorbing property can be effectively improved and at the same time, the glossiness of the surface of the ink receiving layer can be enhanced. Here, there is no particular lower limit of the average primary particle size of the fine particles, but the average primary particle size is preferably 1 nm or more.

Among the fine particles, gas-phase silica or gas-phase aluminum manufactured by the gas phase method has a high specific surface area, and provides the layer with a higher ink absorption and retention capacity. In addition, the silica has a low refractive index, and thus if dispersed to a suitable particle diameter, provides the ink receiving layer with better transparency, and higher color density and favorable coloring is obtainable. The transparency of ink receiving layer is important from the viewpoint of obtaining a high color density and favorable coloring glossiness not only for applications wherein the transparency is required such as OHP sheets and the like, but also for applications as recording sheets such as photographic glossy papers and the like.

In particular with silica fine particles, since the surface has silanol groups, there is easy adhesion between the particles through the hydrogen bonding of the silanol groups, and there is an adhesion effect between the particles through the silanol groups and the water soluble resin. Hence, if the average primary size of the particles is 15 nm or below, then the void ratio of the ink receiving layer is high, and a structure with high transparency can be formed, and the ink absorption ability characteristics can be effectively raised.

Silica fine particles are commonly classified roughly into wet method (precipitation) particles and dry method (gas phase method) particles according to the method of manufacture. By the wet method, silica fine particles are mainly produced by generating an activated silica by acid decomposition of a silicate, polymerizing to a proper degree the activated silica, and coagulating the resulting silica to give a hydrated silica. Alternatively by the gas phase method, gas phase method silica (anhydrous silica) particles are mainly produced by high-temperature gas-phase hydrolysis of a silicon halide (flame hydrolysis process), or by reductively heating and vaporizing quartz and coke in an electric furnace by applying an arc discharge and then oxidizing the vaporized silica with air (arc method). The “gas phase method silica” means an anhydrous silica fine particles produced by a gas phase method.

The gas phase method silica is different in the density of silanol groups on the surface and the presence of voids therein and exhibits different properties from hydrated silica. The gas phase method silica is suitable for forming a three-dimensional structure having a higher void ratio. The reason is not clearly understood. In the case of hydrated silica, the fine particles have a higher density of 5 to 8 silanol groups/nm² on their surface. Thus the silica fine particles tend to aggregate densely. While the gas phase method silica particles have a lower density of 2 to 3 silanol groups/nm² on their surface. Therefore, gas phase method silica seems to cause more scarce, softer coagulations (flocculates), consequently leading to a structure having a higher void ratio.

The fine particles in the invention are preferably amorphous silica or alumina fine particles synthesized by a precipitation method or a gas phase method. It is particularly preferable to use gas phase method silica or gas phase method alumina having an average primary particle diameter of 30 nm or less, and a remarkable effect may be achieved when the gas phase method silica or gas phase method alumina is used at an amount of 50% by mass or more (preferably 70% by mass or more, and more preferably 90% by mass or more) relative to the whole fine particles. When gas phase method silica is used, the silica fine particles preferably have 2 to 3 silanol groups per nm² of the surface of fine particles.

In the invention, gas phase method alumina exhibits higher color density and glossiness than gas phase method silica. This is considered due to the following. The gas phase method alumina has a higher refractive index, thus more effectively reflect light on the surface than gas phase method silica. Furthermore, gas phase method alumina comprises spherical particles and has a superior ink absorptive property to aluminum hydrates such as pseudo-boehmite. Accordingly, it is possible to further improve the ink absorptive property by combining the invention and gas phase method alumina. Furthermore, for some reason, gas phase method alumina less tends to cause minute cracking of the ink-receiving layer than gas phase method silica. Such minute cracking occur due to various factors during manufacturing. For example, minute cracking caused by the shrinkage of a coating film during a drying process can be significantly reduced by using gas phase method alumina.

When gas phase method alumina is used, the strength of a coating film tends to be higher, and failures such as scratch less tend to occur than the cases where gas phase method silica is used. Furthermore, in comparison with gas phase method silica, gas phase method alumina can more effectively increase the solid content of a pigment dispersion liquid, which increases the solid content of the final coating liquid, and allows a production method with a less drying load and a high productivity. In the preparation of an aqueous dispersion of gas phase method alumina, the solid content of the dispersion can be further increased by adding a small amount of an acidic component. As the acidic component, it is particularly preferable to add a small amount of boric acid during the dispersion of an pigment.

For the sake of increasing the concentration of a pigment dispersion, it is preferable to use a known dispersant. Examples of preferable dispersant include cationic polymers, nonionic or cationic surfactants, and low molecular weight polyvinyl alcohols having secondary or tertiary amino group, or quaternary ammonium base. Furthermore, the concentration of a dispersion can be further increased by adding a high boiling point solvent which can be used in the invention during the dispersion of a pigment.

When gas phase method alumina is used as the fine particles, the usage is preferably 4 parts by mass to 12 parts by mass, more preferably 5 parts by mass to 10 parts by mass, and particularly preferably 6 parts by mass to 9 parts by mass relative to 1 parts by mass of a water-soluble binder. Accordingly, sufficient layer strength can be achieved with a less amount of binder than the cases where gas phase method silica is used.

When a multilayer ink-receiving layer is prepared, it is preferable to include gas phase method alumina in the outermost layer for exploiting the feature of the gas phase method alumina.

In the invention, the fine particles may be used alone, or in combination of two or more types of them. When two or more types of fine particles are used in combination, it is preferable to use any two or more of precipitation silica, gas phase method silica, and gas phase method alumina in combination.

When organic fine particles are used as the fine particles in the invention, they must be present in a particle state when an ink-receiving layer is formed. Examples of the organic fine particles include polymer fine particles obtained by emulsion polymerization, microemulsion-based polymerization, soap free polymerization, seed polymerization, dispersion polymerization, suspension polymerization, or the like, and specific examples thereof include powder, latex or emulsion of polymer fine particles of polyethylene, polypropylene, polystyrene, polyacrylate, polyamide, silicone resins, phenolic resins, natural polymer, and others. The surface of the organic fine particles is preferably cationized. The Tg of the organic fine particles is not specifically limited, however when they are used alone, preferably 40° C. or higher, and more preferably 80° C. or higher.

When only colloidal silica is used as the fine particles, the effect of the invention may not be achieved in some cases because colloidal silica itself has poor ability to form voids. However, the effect of the invention can be achieved at a higher level in cases where, for example, colloidal silica is used in combination with precipitation silica or gas phase method silica within the same layer, or a colloidal silica-containing layer is provided as an additional layer besides the layer containing the fine particles such as precipitation silica, gas phase method silica.

Ratio of the Fine Particles to the Water-Soluble Resin Contained

The ratio (PB ratio: x/y, mass of fine particles relative to 1 parts by mass of water soluble resin) of the content of fine particles (preferably silica fine particles; x) to the content of water-soluble resin (y) has a great influence on the layer structure of the ink receiving layer. A larger PB ratio tends to result in increase in void ratio, pore volume, and surface area (per unit mass).

Specifically the PB ratio (x/y) for the ink receiving layer is preferably 1.5/1 to 10/1, from the viewpoints of suppressing the decrease in layer strength and prevention of cracking thereof when drying which may be caused due to an excessively high PB value, and preventing a decrease in void ratio and thus in ink absorptive property due to an larger amount of voids blocked more easily due to an excessively low PB ratio.

When conveyed in paper-conveying systems of ink jet printers, a stress may be applied to the ink jet recording medium. Accordingly, the ink receiving layer should have sufficiently high layer strength. Also from the viewpoints of preventing cracking, peeling, or the like of the ink receiving layer when the ink jet recording medium are cut into sheets, the ink receiving layer should have sufficiently high layer strength. Considering the above, the PB ratio (x/y) is preferably 6/1 or less. On the other hand, from the viewpoint of ensuring the superior ink absorptive property in ink jet printers, the ratio is more preferably 3/1 or more.

For example, when a coating liquid, containing anhydrous silica fine particles, having an average primary particle diameter of 20 nm or less, and a water-soluble resin homogeneously dispersed in an aqueous solution at a PB ratio (x/y) of between 3/1 and 6/1, is applied and dried on a support, a three-dimensional network structure having the secondary particles of silica fine particles as the network chains is formed. Such a coating liquid easily provides a translucent porous layer having an average void diameter of 30 nm or less, a void ratio of 50 to 80%, a void specific volume of 0.5 ml/g or more, and a specific surface area of 100 m²/g or more.

Cationic Polymer

The ink jet recording medium preferably contains a cationic polymer from the viewpoint of preventing bleeding over time.

As the cationic polymer in the invention, polymer mordants having a primary to tertiary amino group, or a quaternary ammonium base as a cationic group are preferably used, and cationic nonpolymer mordants are also useable.

The cationic polymer is preferably a homopolymer of a monomer (mordant monomer) having a primary to tertiary amino group or a salt thereof, or a quaternary ammonium base, or a copolymer or a condensation polymer of the mordant monomer and another monomer (hereinafter referred to as “non-mordant monomer”). These polymers may be in either forms of water-soluble polymer or water-dispersibile latex particles when they are used.

Examples of the above monomer (mordant monomer) include trimethyl-p-vinylbenzylammonium chloride, trimethyl-m-vinylbenzylammonium chloride, triethyl-p-vinylbenzyl ammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinyl benzyl ammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride,

trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzyl ammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl-N2-(4-vinylphenyl)ethylammonium acetate;
quaternary compounds obtained by reacting methyl chlorides, ethyl chlorides, methyl bromides, ethyl bromides, methyl iodides, or ethyl iodides of N,N-dimethylaminoethyl (meth)acrylate, N,N-diethylaminoethyl(meth)acrylate, N,N-dimethylaminopropyl(meth) acrylate, N,N-diethylaminopropyl(meth)acrylate, N,N-dimethylaminoethyl(meth) acrylamide, N,N-diethylaminoethyl(meth)acrylamide, N,N-dimethylaminopropyl(meth) acrylamide, or N,N-diethylaminopropyl(meth)acrylamide; and sulfonates, alkyl sulfonates, acetates, or alkyl carboxylates derived from the quaternary compounds by replacement of the anion.

Specific examples of such compounds include monomethyldiallylammonium chloride, trimethyl-2-(methacryloyloxy)ethylammonium chloride, triethyl-2-(methacryloyloxy)ethylammonium chloride, trimethyl-2-(acryloyloxy)ethylammonium chloride, triethyl-2-(acryloyloxy)ethylammonium chloride, trimethyl-3-(methacryloyloxy) propylammonium chloride, triethyl-3-(methacryloyloxy)propylammonium chloride, trimethyl-2-(methacryloylamino)ethylammonium chloride, triethyl-2-(methacryloylamino) ethylammonium chloride, trimethyl-2-(acryloylamino)ethylammonium chloride, triethyl-2-(acryloylamino)ethylammonium chloride, trimethyl-3-(methacryloylamino) propylammonium chloride, triethyl-3-(methacryloylamino)propylammonium chloride, trimethyl-3-(acryloylamino) propylammonium chloride, triethyl-3-(acryloylamino) propylammonium chloride,

N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy)ethyl ammonium bromide, trimethyl-3-(acryloylamino)propylammonium bromide, trimethyl-2-(methacryloyloxy)ethylammonium sulfonate, and trimethyl-3-(acryloylamino) propylammonium acetate.

Examples of other copolymerizable monomers include N-vinylimidazole and N-vinyl-2-methylimidazole.

Further, allylamine, diallyamine, and derivatives and salts thereof may also be used. Examples of these compounds include allylamine, allylamine hydrochloride, allylamine acetate, allylamine sulfate, diallyamine, diallyamine hydrochloride, diallyamine acetate, diallyamine sulfate, diallylmethylamine and the salts thereof (e.g., hydrochloride, acetate, and sulfate salts, and the like), diallylethylamine and the salts thereof (e.g., hydrochloride, acetate, and sulfate salts, and the like), diallyldimethylammonium salts (counter anions thereof including chloride, acetate, and sulfate ions), and the like. These allylamine and diallyamine derivatives are less polymerizable in the amine form, and thus are commonly polymerized in the salt form and desalted thereafter if necessary. Further, polymerization units, such as N-vinylacetamide and N-vinylformamide, can be used, to give vinylamine units by hydrolyzation after polymerization, or salts thereof can be used.

The term “a non-mordant monomer” refers to a monomer that does not have a basic or cationic moiety, such as a primary, secondary or tertiary amino group, a salt thereof, or a quaternary ammonium salt group, and exhibits no or substantially little interaction with dye in inkjet ink.

Examples of non-mordant monomers include alkyl(meth)acrylates; cycloalkyl (meth)acrylates such as cyclohexyl(meth)acrylate; aryl(meth)acrylates such as phenyl (meth)acrylate; aralkyl esters such as benzyl(meth)acrylate; aromatic vinyl compounds such as styrene, vinyltoluene and α-methylstyrene; vinyl esters such as vinyl acetate, vinyl propionate and vinyl versatate; allyl esters such as allyl acetate; halogen-containing monomers such as vinylidene chloride and vinyl chloride; vinyl cyanides such as (meth)acrylonitrile; and olefins such as ethylene and propylene.

The above alkyl(meth)acrylate preferably has 1 to 18 carbon atoms in the alkyl moiety. Examples of such alkyl(meth)acrylates include methyl(meth)acrylate, ethyl (meth)acrylate, propyl(meth)acrylate, isopropyl(meth)acrylate, n-butyl(meth)acrylate, isobutyl(meth)acrylate, tert-butyl(meth)acrylate, hexyl(meth)acrylate, octyl(meth)acrylate, 2-ethylhexyl(meth)acrylate, lauryl(meth)acrylate, and stearyl(meth)acrylate.

Particularly preferred are methyl acrylate, ethyl acrylate, methyl methacrylate, ethyl methacrylate, and hydroxyethyl methacrylate.

One kind of non-mordant monomer may be used alone or two or more kinds of non-mordant monomers may be used in combination.

Furthermore, preferable examples of the above-described cationic polymer include polydiallyldimethylammonium chloride, polymethacryloyloxyethyl-p-hydroxyethyl dimethylammonium chloride, polyethyleneimine, polyallylamine and derivatives thereof, polyamide-polyamine resins, cationized starch, dicyandiamide-formalin condensate, dimethyl-2-hydroxypropylammonium salt polymer, polyamidine, polyvinylamine, dicyan-based cationic resins typified by dicyandiamide-formalin polycondensate, polyamine-based cationic resins typified by dicyanamide-diethylene triamine polycondensate, epichlorohydrin-dimethylamine addition polymer, dimethyl hypophosphite ammonium chloride-SO₂ copolymer, diallylamine salt-SO₂ copolymer, polymers containing (meth)acrylate having a quaternary ammonium base substituted alkyl group at the ester part, and styryl polymers having a quaternary ammonium base substituted alkyl group.

Specific examples of the above-described cationic polymer include those described in JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134, and 1-161236, U.S. Pat. Nos. 2,484,430, 2,548,564, 3,148,061, 3,309,690, 4,115,124, 4,124,386, 4,193,800, 4,273,853, 4,282,305, and 4,450,224, JP-A Nos. 1-161236, 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314, JP-B Nos. 5-35162, 5-35163, 5-35164, and 5-88846, JP-A Nos. 7-118333, 2000-344990, and Japanese Patent Nos. 2648847 and 2661677. Among them, diallyldimethylammonium chloride type polymers and polymers containing (meth)acrylate having a quaternary ammonium base substituted alkyl group at the ester part are preferable.

The cationic polymer in the invention preferably has a weight average molecular weight of 200000 and an I/O value of 3.0 or less specifically from the viewpoint of preventing bleeding over time.

The cationic polymers may be used alone or in combination of two or more of them. Also, the cationic polymers may be used in combination of other organic mordants and/or inorganic mordants. The content of the cationic polymer contained in the ink-receiving layer formed in the invention is preferably low from the viewpoint of ozone resistance, and preferably 1 to 30% by mass, more preferably 2 to 15% by mass, and further preferably 3 to 10% by mass relative to the mass of total solid content in the ink receiving layer.

Latex

The ink-receiving layer formed according to the invention further preferably contains a latex having a volume average particle diameter of 0.1 μm or less.

In the invention, the term latex means a colloid dispersion liquid or an emulsion liquid in which a polymer insoluble in water is emulsified or dispersed in water. When the particle size is 0.1 μm or more, the liquid is referred to as an emulsion, and when less than 0.1 μm, the liquid is referred to as a colloid dispersion liquid. The lower limit of the volume-average particle diameter of the latex is not specifically limited, but preferably 1 nm or more.

In the invention, the latex used in combination of the cationic polymer can improve the ink jet recording medium prepared according to the invention as to its effects such as the prevention of scratches on the surface of an image-receiving layer during printing with a printer, and prevention of bleeding by moisture or heat after printing.

The volume average particle diameter of the latex in water is preferably less than 0.1 μm (a colloid dispersion liquid), and more preferably within the range of 1 to 100 nm.

For the water dispersion of a latex or polymer, for example, polystyrene-based, styrene-butadiene copolymer-based, acrylonitrile-butadiene-based, acryl-based, styrene-acryl, urethane-based, methacrylic acid-based, vinyl chloride-based, vinyl acetate-based, ethylene-vinyl acetate-based latexes are preferably used. Among them, styrene-based, acrylic acid-based, methacrylic acid-based, and urethane-based latexes are preferable, and urethane-based-latex is particularly preferable from the viewpoint of preventing bleeding after printing.

As the latex in the invention, those synthesized by a known polymerization method described in “Latex Emulsion no Saishin Oyo Gijutu (Newest Applied Technology of Latex Emulsion)”, written by Motoharu Okikura, published by Chunichisha (1991) can be used. Specifically, the latex used in the invention is preferably synthesized using no surfactant from the viewpoint of improving the layer strength.

When a latex having an average primary particle diameter of 30 nm or less and a water-soluble resin is used in the ink-receiving layer coating liquid containing fine particles, the viscosity of the coating liquid increases, which may cause the deterioration of the coated surface condition, or deterioration of glossiness. However, in the invention, particularly when a specified high boiling point organic solvent which will be described later is contained in the ink-receiving layer coating liquid, even when a latex is used, the viscosity stabilizing effect of the coating liquid is exerted to readily achieve a favorable coated surface condition.

The Tg of the latex is not specifically limited, but preferably 40° C. or higher from the viewpoint of improving the layer hardness, on the other hand preferably 40° C. or lower from the viewpoint of improving the brittleness. Furthermore, a latex of a cation modified polyurethane resin preferably does not form a particulate state but forms a film after drying. The film formation decreases the haze of the ink-receiving layer, which allows achieving a high color density As the latex in the invention, a latex of a cation modified polymer whose dispersion has a volume average particle diameter of 0.1 μm or less (preferably 200 nm or less) is preferable, and a latex of a cation modified polyurethane resin is particularly preferable. The latex of a cation modified polymer is described in more detail below.

More specific examples of the above “cation modified polymer” of the invention are, for example, poly-addition or polycondensation based polymer compounds including a cationic group such as a primary, secondary or tertiary amine group, or a quaternary ammonium group.

Vinyl polymers effective as the cation-modified polymers include polymers obtained by the polymerization of the following vinyl monomers. Examples include: acrylic acid esters and methacrylic acid esters (the ester group may be a substituted or unsubstituted alkyl group or a substituted or unsubstituted aryl group, for example the following groups can be used, methyl, ethyl, n-propyl, isopropyl, n-butyl, sec-butyl, tert-butyl, hexyl, 2-ethylhexyl, tert-octyl, 2-chloroethyl, cyanoethyl, 2-acetoxyethyl, tetrahydrofurfuryl, 5-hydroxypentyl, cyclohexyl, benzyl, hydroxyethyl, 3-methoxybutyl, 2-(2-methoxyetoxy)ethyl, 2,2,2-tetrafluoroethyl, 1H,1H,2H,2H-perfluorodecyl, phenyl, 2,4,5-tetramethyl phenyl, 4-chlorophenyl);

vinyl esters, specifically aliphatic carboxylic acid vinyl esters which may have a substituent (for example, vinyl acetate, vinyl propionate, vinylbutyrate, vinyl isobutyrate, vinylcaproate, vinylchloroacetate), aromatic carboxylic acid esters which may have a substituent (for example vinyl benzoate, 4-methyl benzoic acid vinyl, vinyl salicylate);
acrylamides, specifically acrylamide, N-mono substituted acrylamides, N-disubstituted acrylamides (example of the substituents include alkyl, aryl, and silyl groups which may have a substituent—for example methyl, n-propyl, isopropyl, n-butyl, tert-butyl, tert-octyl, cyclohexyl, benzyl, hydroxy methyl, alkoxy methyl, phenyl, 2,4,5-tetramethyl phenyl, 4-chlorophenyl, trimethyl silyl groups);
methacrylamides, specifically methacrylamides, N-monosubstituted methacrylamides, N-disubstituted methacrylamides (examples of the substituents include alkyl, aryl, and silyl groups which may have a substituent—for example methyl, n-propyl, isopropyl, n-butyl, tert-butyl, tert-octyl, cyclohexyl, benzyl, hydroxy methyl, alkoxy methyl, phenyl, 2,4,5-tetramethyl phenyl, 4-chlorophenyl, trimethyl silyl groups);
olefins (for example ethylene, propylene, 1-pentene, vinyl chloride, vinylidene chloride, isoprene, chloroprene, butadiene), styrenes (for example styrene, methylstyrene, isopropylstyrene, methoxystyrene, acetoxystyrene, and chlorostyrene), vinyl ethers (for example methyl vinyl ether, butyl vinyl ether, hexyl vinyl ether, and methoxyethyl vinyl ether).

Examples of the vinyl monomer further include crotonate esters, itaconate esters, maleate diesters, fumarate diesters, methyl vinyl ketone, phenyl vinyl ketone, methoxyethyl vinyl ketone, N-vinyloxazolidone, N-vinylpyrrolidone, methylenemalonnitrile, diphenyl-2-acryloyloxyethyl phosphate, dipheyl-2-methacryloyloxyethyl phosphate, dibutyl-2-acryloyloxyethyl phosphate, dioctyl-2-methacryloyloxyethyl phosphate and the like.

As the above-mentioned monomer having a cationic group, there are, for example, monomers having a tertiary amino group, such as dialkylaminoethyl methacrylates, dialkylaminoethyl acrylates and the like.

As polyurethanes applicable to the cation modified polymer, there are, for example, polyurethanes synthesized by the addition polymerization reaction of various combinations of the diol compounds with the diisocyanate compounds listed below.

Examples of the above-mentioned diol compound include ethylene glycol, 1,2-propanediol, 1,3-propanediol, 1,2-butanediol, 1,3-butanediol, 2,3-butanediol, 2,2-dimethyl-1,3-propanediol, 1,2-pentanediol, 1,4-pentanediol, 1,5-pentanediol, 2,4-pentanediol, 3,3-dimethyl-1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2,4-dimethyl-2,4-pentanediol, 1,7-heptanediol, 2-methyl-2-propyl-1,3-propanediol, 2,5-dimethyl-2,5-hexanediol, 2-ethyl-1,3-hexanediol, 1,2-octanediol, 1,8-octanediol, 2,2,4-trimethyl-1,3-pentanediol, 1,4-cyclohexanedimethanol, hydroquinone, diethylene glycol, triethylene glycol, dipropylene glycol, tripropylene glycol, polyethylene glycols (average molecular weight=200, 300, 400, 600, 1000, 1500, 4000), polypropylene glycols (average molecular weight=200, 400, 1000), polyester polyols, 4,4′-dihydroxy-diphenyl-2,2-propane, 4,4′-dihydroxyphenylsulfonic acid, polycarbonate polyols, and the like.

As the above-mentioned diisocyanate compound, examples include methylene diisocyanate, ethylene diisocyanate, isophorone diisocyanate, hexamethylene diisocyanate, 1,4-cyclohexane diisocyanate, 2,4-toluene diisocyanate, 2,6-toluene diisocyanate, 1,3-xylylene diisocyanate, 1,5-naphthalene diisocyanate, m-phenylene diisocyanate, p-phenylene diisocyanate, 3,3′-dimethyl-4,4′-diphenylmethane diisocyanate, 3,3′-dimethylbiphenylene diisocyanate, 4,4′-biphenylene diisocyanate, dicyclohexylmethane diisocyanate, methylene bis(4-cyclohexyl isocyanate), and the like.

As the cationic group contained in the cationic group-containing polyurethane, there are cationic groups such as primary, secondary and tertiary amines and quaternary ammonium salts. In the polymer used for the latex of the invention, it is preferable to use a urethane resin having a cationic group such as a tertiary amine or quaternary ammonium salt. The cationic group-containing polyurethanes can be obtained, for example, by introducing a cationic group to the above diol at the time of synthesizing the polyurethane. Also, in the case of quaternary ammonium salts, polyurethanes containing a tertiary amino group can be quaternized with a quaternizing agent.

The diol compounds and diisocyanate compounds usable for synthesizing the polyurethane may be used each alone, or may be used in combinations of two or more in various proportions decided depending on the purpose (for example, control of the polymer glass transition temperature (Tg), improving solubility, providing compatibility with a binder, and improving stability of a dispersion).

As the polyester applicable to the cation modified polymer, there are, for example, polyesters synthesized by polycondensation reactions of various combinations of the diol compounds with the dicarboxylic acid compounds listed below.

As the above-mentioned dicarboxylic acid compounds, there are listed oxalic acid, malonic acid, succinic acid, glutaric acid, dimethylmaleic acid, adipic acid, pimelic acid, α,α-dimethylsuccinic acid, acetonedicarboxylic acid, sebacic acid, 1,9-nonanedicarboxylic acid, fumaric acid, maleic acid, itaconic acid, citraconic acid, phthalic acid, isophthalic acid, terephthalic acid, 2-butylterephthalic acid, tetrachloroterephthalic acid, acetylenedicarboxylic acid, poly(ethyleneterephthalate)dicarboxylic acid, 1,2-cyclohexanedicarboxylic acid, 1,4-cyclohexanedicarboxylic acid, ω-poly(ethyleneoxide)dicarboxylic acid, ω-xylylenedicarboxylic acid and the like.

The above-mentioned dicarboxylic acid compound may, when polycondensed with a diol compound, be used in the form of an alkyl ester (for example, dimethyl ester) of a dicarboxylic acid or an acid chloride of a dicarboxylic acid, or be used in the form of an acid anhydride such as maleic anhydride, succinic anhydride and phthalic anhydride.

As the diol compound, the same compounds as the diols exemplified for the above-mentioned polyurethane can be used.

The cationic group-containing polyester can be obtained by synthesis using a dicarboxylic acid compound having a cationic group such as a primary, secondary or tertiary amine a quaternary ammonium salt.

The above-mentioned diol compounds, dicarboxylic acids and hydroxycarboxylate ester compounds used in synthesis of the polyester may each be used alone, or may be used in combinations of two or more in selected proportions depending on the purpose (for example, control of the polymer glass transition temperature (Tg), solubility, compatibility with dyes, and stability of dispersion).

The content of the cationic group in the cation modified polymer is preferably from 0.1 to 5 mmol/g, and more preferably from 0.2 to 3 mmol/g. When the content of the cationic group is too low, the polymer dispersion stability may decrease, and when too high, binder compatibility may decrease.

The above cation-modified polymer is preferably a polymer including a cationic group such as a tertiary amino group or a quaternary ammonium salt, and more preferably a cationic-group containing urethane resin which is described as above.

When the above cation-modified polymer is used in an ink receiving layer of the invention, particularly important is the glass transition temperature thereof. After forming an image by inkjet recording, in order to suppress the occurrence of bleeding with the passage of time, the glass transition temperature of the cation-modified polymer is preferably below 50° C. Further, the glass transition temperature of the cation-modified polymer is more preferably 30° C. or below, and even particularly preferable is a glass transition temperature of 15° C. or below. If the glass transition temperature is 50° C. or above then the dimensional stability (curl) worsens. Here, there is no particular lower limit to the glass transition temperature but, for normal applications it is of the order of −30° C., and if it is lower than this then when preparing the aqueous dispersant the manufacturability can be reduced.

For the weight average molecular weight of the cation-modified polymer used in the invention, usually this is preferably 1000 to 1,000,000, and more preferably 300,000 to 700,000. If the weight average molecular weight is less than 1000 then there is a tendency that obtaining a stable aqueous dispersant becomes difficult. If the molecular weight exceeds 1,000,000 then the solubility may decrease, the viscosity of the liquid may increase and the controlling to a small average particle size the particles of aqueous dispersant tends to become difficult, particularly controlling to 0.05 cm or less.

Regarding the amount of the aqueous dispersant of a latex or polymer which is the above cation-modified polymer to be included in the ink receiving layer of the invention, this is preferably in the range of 0.1 to 30 mass % relative to the total solid contents in the structure of the ink receiving layer, 0.3 to 20 mass % is more preferable and 0.5 to 15 mass % is most favorable. If the above amount included is less than 0.1 mass % then there is insufficient improvement in the bleeding which occurs with the passage of time. On the other hand, if the amount included is over 30 mass % then the proportion of fine particles or binder components gets smaller, and the ink absorption ability on a high quality image recording paper tends to be reduced.

Next, the preparation method of the cation-modified polymer of the invention will be explained.

The above cation-modified polymer is mixed into an aqueous solvent medium, and as required additives are mixed in, and by fragmenting the mixture liquid using a dispersal apparatus, an aqueous dispersion with an average particle size of 0.05 cm or below can be obtained. In order to obtain the aqueous dispersion, various known dispersal apparatuses such as the following can be used: high speed rotary dispersal apparatus, a medium agitation type dispersal apparatus (such as a ball mill, sand mill, bead mill), ultra-sound dispersal apparatus, colloid mill dispersal apparatus, high pressure dispersal apparatus. However, from the perspective of efficiently dispersing the clump-like fine particles, a medium agitation type dispersal apparatus, colloid mill dispersal apparatus or high pressure dispersal apparatus are preferable.

As a high pressure dispersal apparatus (homogenizer) there is the structure described in U.S. Pat. No. 4,533,254, JP-A No. 6-47264 and the like but commercially available apparatuses such as GAULIN HOMOGENIZER (A.P.V Gaulin Inc.), MICROFLUIDIZER (Microfluidex Inc.), ALTIMIZER (Sugino Machine K.K.) can be used. Recently, a high pressure homogenizer equipped with a mechanism to form fine particles in an ultrahigh pressure jet flow as described in U.S. Pat. No. 5,720,551 is particularly effective for emulsifying dispersion of the present invention. DeBEE2000 (Bee International Ltd.) is as an example of an emulsifying apparatus using an ultrahigh pressure jet flow. Among them, the high pressure homoginizers are preferable since monodispersibility of fine particles can be easily obtained, the haze value of the ink receiving layer can be lowered, and the high void ratio can be obtained.

For the aqueous medium used in the above dispersing process the following can be used water, organic solvents, or mixtures thereof. Examples of the useable organic solvents for the dispersing include alcohols such as methanol, ethanol, n-propanol, i-propanol, and methoxy propanol; ketones such as acetone, methyl ethyl ketone; tetrahydrofuran, acetonitrile, ethyl acetate, toluene.

With the above cation-modified polymer, while with the polymer itself a stable emulsion dispersion can be obtained naturally, in order to speed up the emulsifying dispersion and to make it more stable, a small amount of dispersant (surfactant) can be used. For this purpose various surfactants can be used. Preferable examples include anionic surfactants such as fatty acid salts, alkylsulfate ester salts, alkylbenzenesulfonate salts, alkylnaphthalenesulfonate salts, dialkylsulfosuccinate salts, alkylphosphate ester salts, naphthalenesulfonic acid formalin condensates, polyoxyethylene alkylsulfate ester salts and the like. And nonionic surfactants such as polyoxyethylene alkyl ethers, polyoxyethylene alkylaryl ether, polyoxyethylene fatty acid esters, sorbitan fatty acid esters, polyoxyethylene sorbitan fatty acid esters, polyoxyethylene alkyl amines, glycerine fatty acid esters, oxyethylene oxypropylene block copolymers and the like. Further, SURFYNOLS (Air Products & Chemicals), an acetylene-based polyoxyethylene oxide surfactant is also preferably used. Furthermore, amine oxide type ampholytic surfactants such as N,N-dimethyl-N-alkylamine oxide, and the like are also preferable. Further, surfactants listed in JP-A No. 59-157,636, pp. (37) to (38) and Research Disclosure No. 308119 (1989) can be used.

For obtaining stability directly after emulsification, a water-soluble polymer can also be added together with the above-mentioned surfactant. As the water-soluble polymer, polyvinyl alcohols, polyvinylpyrrolidone, polyethylene oxide, polyacrylic acid, polyacrylamide, and copolymers thereof are preferably used. Further, it is also preferable to use naturally occurring water-soluble polymers such as polysaccharides, casein, gelatin and the like.

In the above emulsifying method, when dispersing the above cation-modified polymer of the invention in an aqueous medium, particularly important is control of the particle size. When forming an image using an inkjet process, in order to raise the color purity and color density, it is necessary to make the average size of the particles of the cation-modified polymer of the above aqueous dispersion small.

Cross-Linking Agent

With respect to the ink receiving layer formed according to the invention, it is preferable that the layer containing inorganic fine particles, a water-soluble resin, and the like, contains additionally a cross-linking agent that allows cross-linking of the water-soluble resin, and thus is a porous layer hardened by the cross-linking reaction between the cross-linking agent and the water-soluble resin.

The above crosslinking agent may be selected appropriately in relation to the water-soluble resin contained in the ink receiving layer, but boron compounds are preferable, as they allow faster crosslinking reaction. Examples of the boron compounds include borax, boric acid, borate salts [e.g., orthoborate salts, InBO₃, ScBO₃, YBO₃, LaBO₃, Mg₃(BO₃)₂, and CO₃(BO₃)₂], diborate salts [e.g., Mg₂B₂O₅, and CO₂B₂O], metaborate salts [e.g., LiBO₂, Ca(BO₂)₂, NaBO₂, and KBO2], tetraborate salts [e.g., Na₂B₄O₇ 10H₂O], pentaborate salts [e.g., KB₅O₈.4H₂O, Ca₂B₆O₁₁.7H₂O, and CsB₅O₅], and the like. Among them, borax, boric acid and borates are preferable since they are able to promptly cause a cross-linking reaction. Particularly, boric acid is preferable, and the combination of polyvinyl alcohol and boric acid is most preferred.

In the invention, the above cross-linking agent is preferably included to an amount of 0.05 to 0.50 parts by mass relative to 1.0 part by mass of the water soluble resin. More preferable is an inclusion amount of 0.08 to 0.30 parts by mass. If the amount of inclusion of the cross-linking agent is within the above ranges then the water soluble resin can be effectively cross-linked and development of cracks and the like can be prevented.

When gelatin and the like are used as a water-soluble resin in the invention, other compounds than the boron compounds, as described below, can be used for the cross-linking agent of the water-soluble resin.

Examples of such cross-linking agents include: aldehyde compounds such as formaldehyde, glyoxal and glutaraldehyde; ketone compounds such as diacetyl and cyclopentanedione; active halogen compounds such as bis(2-chloroethylurea)-2-hydroxy-4,6-dichloro-1,3,5-triazine and 2,4-dichloro-6-S-triazine sodium salt; active vinyl compounds such as divinyl sulfonic acid, 1,3-vinylsulfonyl-2-propanol, N,N′-ethylenebis(vinylsulfonylacetamide) and 1,3,5-triacryloyl-hexahydro-S-triazine; N-methylol compounds such as dimethylolurea and methylol dimethylhydantoin; melamine resin such as methylolmelamine and alkylated methylolmelamine; epoxy resins; isocyanate compounds such as 1,6-hexamethylenediisocyanate; aziridine compounds such as those described in U.S. Pat. Nos. 3,017,280 and 2,983,611; carboxylmide compounds such as those described in U.S. Pat. No. 3,100,704; epoxy compounds such as glycerol triglycidyl ether; ethyleneimino compounds such as 1,6-hexamethylene-N,N′-bisethylene urea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chromium alum, potassium alum, zirconyl acetate and chromium acetate; polyamine compounds such as tetraethylene pentamine; hydrazide compounds such as adipic acid dihydrazide; and low molecular compounds or polymers containing at least two oxazoline groups. These cross-linking agent may be used alone, or in combinations of two or more thereof.

In the invention, the cross-linking agent can be supplied in a number of ways, such as when forming the ink receiving layer, the above cross-linking agents can be added to the ink receiving layer coating liquid and/or a coating liquid which is used for forming a layer adjacent to the ink receiving layer. Or, a coating liquid which includes the cross-linking agent can be applied in advance onto the support and the ink receiving layer coating liquid can be coated. Or, a solution of the cross-linking agent can be over-coated onto a coating of an ink receiving layer coating liquid not containing cross-linking agent after it has dried. From the perspective of manufacturing efficiency, it is preferable that the cross-linking agent is added to the ink receiving layer coating liquid or a coating liquid for forming an adjacent layer, and the cross-linking agent is supplied at the same time as forming the ink receiving layer. In particular, from the perspective of raising the print image density and glossiness of images, it is preferable to include the cross-linking agent in the coating liquid for the ink receiving layer. It is preferable that the concentration of the cross-linking agent in the ink receiving layer coating liquid is between 0.05 and 10% by mass, and more preferable between 0.1 and 7% by mass.

The cross-linking agent, for example, is preferably added as follows. Here an example will be described where a boron compound is used. When the ink receiving layer is formed through curing by causing cross-linking of the coating layer by applying a coating liquid (first coating liquid) for the ink receiving layer, the layer is cured by cross-linking by applying a basic liquid (second coating liquid) having a pH value of 7.1 or more on the coating layer, either (1) at the same time for forming the coating layer by applying the first coating liquid; or (2) during the drying step of the coating layer formed by applying the first coating liquid and also before the coating layer exhibits a decrease in the rate of drying. The boron compound acting as the cross-linking agent may be contained in either the first coating liquid or the second coating liquid, or alternatively may be contained in both the first coating liquid and the second coating liquid.

Mordant

The ink-receiving layer formed in the invention preferably contains a mordant for the sake of improving water resistance and resistance to bleeding over time of the formed image. As the mordant, either of an organic mordant or inorganic mordant may be used. As the organic mordant, the above-described cationic polymer may also serve as a cationic mordant. As the inorganic mordant, the above-described water-soluble aluminum compound and the above-described water-soluble polyvalent metal salt preferably also serve as a mordant.

Specified High Boiling Point Organic Solvent

The ink-receiving layer formed in the invention preferably contains a specified high boiling point organic solvent. The specified high boiling point organic solvent is an organic solvent having a boiling point of 230° C. or higher.

The specified high boiling point organic solvent must have a boiling point of 230° C. or higher, preferably 240° C. or higher, and further preferably 245° C. from the viewpoint of improving the ability of forming voids in the ink-receiving layer. When the boiling point is lower than 230° C., the ability of forming voids is not improved. The upper limit of the boiling point is not particularly limited, but about 400° C.

The specified high boiling point organic solvent preferably has water solubility of 0.1% or more, more preferably 0.5 to 50%, and particularly preferably 1 to 20%.

When the water solubility of the specified high boiling point organic solvent is within the above-described preferable range, the effect of preventing bleeding by moisture or heat is further improved. Furthermore, the effect of preventing the aggregation of the fine particle dispersion coating liquid is also improved, which allows to achieve a favorable coated surface condition and glossiness.

The rough indication for the water solubility of the specified high boiling point organic solvent is that the specified high boiling point organic solvent dissolves in water at an amount of 0.1% by mass or more at a normal temperature and normal pressure.

The content of the specified high boiling point organic solvent in the ink-receiving layer may be less than 100% by mass, preferably 50% by mass or less, and particularly preferably 10% by mass or less relative to the fine particles which will be described later, from the viewpoint of improving the ability of forming voids in the ink-receiving layer and improving the curl of the ink jet recording medium. The lower limit may be about 0.5% by mass. When the content of the specified high boiling point organic solvent is 100% by mass or more relative to the fine particles, the color development density may decrease, or the capacity of voids formed in the ink-receiving layer may decrease.

Specific examples of the specified high boiling point organic solvent applicable to the invention include triethylene glycol monobutyl ether, tetraethylene glycol monobutyl ether, pentaethylene glycol monobutyl ether, diethylene glycol monobutyl ether acetate, and diethylene glycol monohexyl ether. Among them, acetate-based compounds are particularly preferable. Furthermore, as the specified high boiling point organic solvent, commercial products are also applicable, and examples thereof include BUTYCENOL 20 (manufactured by Kyowa Hakko Kogyo Co., Ltd.), BUTYCENOL 20 ACETATE (manufactured by Kyowa Hakko Kogyo Co., Ltd.), BUTYCENOL 30 (manufactured by Kyowa Hakko Kogyo Co., Ltd.), BUTYCENOL 40 (manufactured by Kyowa Hakko Kogyo Co., Ltd.), and KYOWANOL Hx20 (manufactured by Kyowa Hakko Kogyo Co., Ltd.).

In the preparation of the ink-receiving layer coating liquid, the specified high boiling point organic solvent is added to the layer, for example, by following embodiments: (1) the high boiling point organic solvent is mixed with, stirred together with, or dispersed in fine particles, and then mixed with a water-soluble resin; or (2) the specified high boiling point organic solvent and a water-soluble resin are mixed and dissolved in advance, and then mixed with a fine particle dispersion liquid in which fine particles have been dispersed. The preparation is more preferably conducted by the above-described embodiment (1) from the viewpoint of controlling the viscosity of the ink-receiving layer coating liquid.

### Other Components

In addition, the ink receiving layer formed in the present invention is constructed to contain the following components if necessary.

To restrain the deterioration of the ink colorant, anti-fading agents such as various ultraviolet absorbers, antioxidants and singlet oxygen quenchers may be contained.

Examples of the ultraviolet absorbers include cinnamic acid derivatives, benzophenone derivative and benzotriazolyl phenol derivatives. Specific examples include α-cyano-phenyl cinnamic acid butyl, o-benzotriazole phenol, o-benzotriazole-p-chlorophenol, o-benzotriazole-2,4-di-t-butyl phenol, o-benzotriazole-2,4-di-t-octyl phenol. A hindered phenol compound can be also used as an ultraviolet absorber, and phenol derivatives in which at least one or more of the second position and/or the sixth position is substituted by a branched alkyl group is preferable.

A benzotriazole based ultraviolet absorber, a salicylic acid based ultraviolet absorber, a cyano acrylate based ultraviolet absorber, and oxalic acid anilide based ultraviolet absorber or the like can be also used. For instance, the ultraviolet absorbers as described in JP-A Nos. 47-10537, 58-111942, 58-212844, 59-19945, 59-46646, 59-109055 and 63-53544, Japanese Patent Application Publication (JP-B) Nos. 36-10466, 42-26187, 48-30492, 48-31255, 48-41572 and 48-54965, 50-10726, U.S. Pat. Nos. 2,719,086, 3,707,375, 3,754,919 and 4,220,711 or the like.

An optical brightening agent can be also used as an ultraviolet absorber, and specific examples include a coumalin based optical brightening agent. Specific examples are described in JP-B Nos. 45-4699 and 54-5324 or the like.

Examples of the antioxidants are described in EP 223739, 309401, 309402, 310551, 310552 and 459-416, D.E. Patent No. 3435443, JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, 63-113536, 63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437 and 5-170361, JP-B Nos. 48-43295 and 48-33212, U.S. Pat. Nos. 4,814,262 and 4,980,275.

Specific examples of the antioxidants include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4,-tetrahydroquinoline, nickel cyclohexanoate, 2,2-bis(4-hydroxyphenyl)propane, 1,1-bis(4-hydroxyphenyl)-2-ethylhexane, 2-methyl-4-methoxy-diphenylamine, 1-methyl-2-phenyl indole.

These anti-fading agents can be used singly or in combinations of two or more. The anti-fading agents can be dissolved in water, dispersed, emulsified, or they can be included within microcapsules. The amount of the anti-fading agents added is preferably 0.01 to 10% by mass, relative to the total ink receiving layer coating liquid.

In the invention, in order to prevent curl, it is preferable to include organic solvents with a high boiling point in the ink receiving layer other than the specified high boiling point organic solvent. For the above high boiling point organic solvents water soluble ones are preferable. As water soluble organic solvents with high boiling points the following alcohols are examples: ethylene glycol, propylene glycol, diethylene glycol, triethylene glycol, glycerin, diethylene glycol monobutylether (DEGMBE), triethylene glycol monobutyl ether, glycerin monomethyl ether, 1,2,3-butane triol, 1,2,4-butane triol, 1,2,4-pentane triol, 1,2,6-hexane triol, thiodiglycol, triethanolamine, polyethylene glycol (average molecular weight of 400 or less). Diethylene glycol monobutylether (DEGMBE) is preferable.

The amount of the above high boiling point organic solvents used in the coating liquid for the ink receiving layer is preferably 0.05 to 1% by mass, and particularly favorable is 0.1 to 0.6% by mass.

Also, for the purpose of increasing the dispersability of the inorganic pigment fine particles, an inorganic salt, pH adjusting agent, acid, alkali and the like may be included.

Further, in order to suppress the generation of on the surface of friction charging and exfoliation charging, conductive metallic compound fine particles, and matting agents, for reducing the surface friction, can be included.

Manufacture of Ink Jet Recording Medium

In the ink jet recording medium according to the invention, the ink receiving layer on a support may be formed by applying and drying an ink receiving layer coating liquid containing at least a water-soluble aluminum compound and a sulfoxide compound on the support.

In the invention, it is preferable that the ink receiving is formed on the support by WOW method which will be described later.

The ink jet receiving layer of the ink jet recording medium according to the invention is preferably formed, for example, by the following method (Wet on Wet method or WOW method). In an embodiment, a coating liquid (first coating liquid) containing at least a sulfoxide compound and a water soluble aluminum compound, and preferably fine particles, cationic polymer, a water soluble resin and a high boiling point organic solvent, is applied onto a support to form a coating layer. A crosslinking agent is added to the coating liquid (first coating liquid) and/or a basic liquid (second coating liquid) having a pH value of 7.1 or more. The coating layer is cured by cross-linking by applying the basic liquid (second coating liquid) on the coating layer, either (1) at the same time for forming the coating layer by applying the first coating liquid; or (2) during the drying step of the coating layer formed by applying the first coating liquid and also before the coating layer exhibits a decrease in the rate of drying.

The above cross-linking agent for obtaining cross-linking of the water soluble resin, is preferably added to one or both of the above first coating liquid and second coating liquid. Forming cross-linking of the ink receiving layer in this way by applying the basic liquid (second coating liquid) to the first coating liquid at the above times of (1) the same time, or (2) during drying is particularly preferable to improve the appearance, from the perspective of the ink absorption ability and prevention of cracks in the film, as well as cissing defects.

When the above-described latex is contained in the ink-receiving layer, the latex may be added to at least either of the above-described first coating liquid and second coating liquid (basic solution), and preferably added to the first coating liquid (the coating liquid containing fine particles and a water-soluble resin) from the viewpoint of being thoroughly mixed with the fine particles and the water-soluble resin in the first coating liquid to effectively prevent bleeding over a long period of time. In such cases, the first coating liquid not necessarily has to contain the whole of the latex, however it is also effective that the second coating liquid contains at least a portion of the latex for effectively preventing bleeding over time. Furthermore, it is also preferable that at least a portion of the latex is contained in both of the first and second coating liquids.

The mordant is preferably included such that a thickness from the surface of the ink receiving layer to the portion containing the mordant accounts for preferably 10 to 60% of the total thickness of the ink receiving layer. For example, either of these methods can be selected: (1) forming a coating layer containing the fine particles, the water-soluble resin and the cross-linking agent, followed by coating a mordant-containing solution thereon; or (2) multi-coating, by applying the coating liquid containing the fine particles and water-soluble resin and the mordant-containing solution. Also, inorganic fine particles, water-soluble resin and cross-linking agent may be added to the mordant-containing solution. Forming by the above methods is preferable since significant amount of mordant is then present in a specific portion of the ink receiving layer, and so the ink coloring material of the inkjet can be sufficiently mordanted, and the color density, the tendency to bleed with the lapse in time, glossiness of the printed areas, the water resistance of text and images after printing, and the resistance to ozone can be further improved. A portion of the mordant can be contained in a layer provided at first on the support body. In this case the mordant applied later can be the same mordant or a different mordant.

In the invention, as the first coating liquid, a coating liquid containing inorganic pigment fine particles, water soluble resin and a boron compound (cross-linking agent), can be prepared as set out below.

Silica fine particles with a average particle diameter of 20 nm or below can be added to water (for example, to a silica fine particle concentration in water of 10 to 20% by mass), dispersing the fine particles using a high speed rotational wet-type colloid mill (such as trade name: CLEARMIX, manufactured by M Technique Co., Ltd.) at a high speed rotation of 10,000 rpm (preferably, at 5,000 to 20,000 rpm) for 20 minutes (preferably, for 10 to 30 minutes), then adding a boron compound (for example at a rate of 0.5 to 20%, relative to the silica by mass), dispersal under the same conditions as above, adding an aqueous polyvinyl alcohol (PVA) solution (to make the PVA concentration become about ⅓ of the concentration of the silica), and again dispersing under the same rotating conditions as described above. The thus obtained coating liquid is in the state of a uniform sol, and a porous ink receiving layer having a three-dimensional network structure can be formed by applying the liquid onto the support by the method described below.

Where necessary pH adjusting agents, dispersants, surfactants, anti-foaming agents, anti-static agents and the like can be added to the above first liquid.

In the invention, it is preferable to use a surfactant from the viewpoint of imparting wettability to the support. An anionic surfactant, a cationic surfactant or a nonionic surfactant may be used. Among these, a nonionic surfactant is preferable from the viewpoint that the stability of the image formed by ink jet recording may not be affected. Among nonionic surfactants, those having an HLB value of 11 or more are preferable. Among these, polyoxyethylene laurylether, polyoxyethylene isodecyl ether, polyexyethylene isotridecyl ether, and polyoxyethylen alkylene branched decyl ether are preferable, and polyoxyethyele isodecylether is particularly preferable. Examples of these surfactants include NOIGEN SD 70 and NOIGEN XL 100 available from Dai-ichi Kogyo Seiyaku, Co., Ltd.

Dispersing machines used for the dispersion include various known dispersing machines such as a high speed rotational dispersing machine, medium agitating-type dispersing machine (such as a ball mill and a sand mill), ultrasonic dispersing machine, colloid mill dispersing machine and high pressure dispersing machine. However, the medium agitating-type dispersing machine, colloid mill dispersing machine and high pressure dispersing machine are preferable for efficiently dispersing coagulates of the fine particles.

Water, organic solvents and mixed solvents thereof may be used as the solvent used for preparing each coating liquid. Examples of the organic solvent used for preparing a coating liquid include alcohols such as methanol, ethanol, n-propanol, i-propanol and methoxypropanol, ketones such as acetone and methylethyl ketone, tetrahydrofuran, acetonitrile, ethyl acetate and toluene.

The second coating liquid (basic liquid) containing a surfactant can, for example, be prepared as set out below. That is, mordant (for example 0.1 to 5.0% by mass) and surfactants (for example to a total amount of 0.01 to 1.0% by mass) and, where required, cross-linking agent (0 to 5.0% by mass) can be added to ion exchange water and agitated sufficiently. The pH of the second coating liquid is preferably more than 8.0, and by using pH adjusters such as aqueous ammonia, sodium hydroxide, potassium hydroxide, amine group containing compounds (such as ethylene amine, ethanol amine, diethanol amine, polyallylamine) the pH can be set to 8.0 or above.

The first coating liquid (ink receiving layer coating liquid) can be coated by a known method, such as using an extrusion die coater, an air doctor coater, a blade coater, a rod coater, a knife coater, a squeeze coater, a reverse roll coater, or a bar coater.

While the second coating liquid (basic coating liquid) is applied on the coating layer simultaneously with or after applying the first coating liquid (ink receiving layer coating liquid), the second coating liquid may be applied before the coating layer exhibits a fall in the rate period of drying. In other words, the ink receiving layer is favorably formed by providing the basic liquid before the coating layer exhibits constant rate of drying after

The front surface of the above-described support was subjected to corona discharge treatment, and the first liquid with a flowing rate of 173 ml/m² in a coating amount, and a polyaluminum chloride aqueous solution dilute to 5 fold (trade name: ALUFINE 83, manufactured by Taimei Chemicals Co. Ltd.) with a flowing rate of 10.8 ml/m² are inline-mixed and coated on the support. This was then dried until the solid content of the coating layer became 20% using a hot air drier at 80° C. (at a wind velocity of 3 to 8 m/sec). The coating layer exhibited a constant rate of drying during this period. Before the layer exhibited a falling rate of drying, the layer was soaked in the basic solution B (second liquid) having the following composition for 2 seconds to adhere 13 g/m² of the liquid onto the above-described coating layer, and further dried at 80° C. for 10 minutes (curing process). Thus the ink jet recording medium 1 having provided thereon an ink-receiving layer with a dry film thickness of 35 μm was prepared.

<Composition of basic solution B>

| | | |
|---|---|---|
| (1) | Boric acid | 0.65 parts |
| (2) | Zirconium ammonium carbonate | 1.18 parts |
| | (trade name: Zircosol AC-7 (28% aqueous | |
| | solution), manufactured by Daiichi | |
| | Kigenso Kagaku Kogyo Co. Ltd) | |
| (3) | Ammonium carbonate | 5.0 parts |
| | (first grade, manufactured by Kanto Chemical | |
| | Co., Ltd.) | |
| (4) | Ion exchanged water | 63.17 parts |
| (5) | Polyoxyethylene laurylether (surfactant) | 30.0 parts |
| | (Trade name: EMULGEN 109P (2% aqueous | |
| | solution), manufactured by Kao Corporation) | |

[Preparation of Ink Jet Recording Medium 2]

The ink jet recording medium 2 was prepared in the same manner as the ink jet recording medium 1, except that 1 part of ion exchanged water for the ink-receiving layer coating liquid A was replaced with the following sulfoxide compound 1 (exemplary compound A-41). applying the first coating liquid for the ink receiving layer. A mordant may be added to the second coating liquid.

The phrase “before the coating layer exhibits a falling rate of drying” usually means a process within several minutes from immediately after applying the ink receiving layer coating liquid. During this period the content of the solvent (dispersing medium) in the applied coating layer decreases in proportion to the lapse of time (a constant rate period of drying). The time lapse exhibiting “constant rate period of drying” is described, for example, in Kagaku Kogaku Binran (Chemical Engineering Handbook), pp. 707-712, Maruzen Co. Ltd., 25 Oct., 1980.

The period in which the coating layer is dried until it exhibits a falling rate of drying after applying the first coating liquid, is usually, at 50 to 180° C., for 0.5 to 10 minutes (preferably, 0.5 to 5 minutes). While this drying time differs depending on the amount of coating, the aforementioned range is usually appropriate.

Examples of the method for applying the second coating liquid before the first coating layer exhibits a falling rate period of drying include (1) further coating the second coating liquid on the coating layer, (2) spraying the second coating liquid, and (3) dipping the support on which the coating layer has been disposed in the second coating liquid.

The method used for applying the second coating liquid in the above method (1) includes known application method using, for example, a curtain flow coater, an extrusion die coater, an air doctor coater, a blade coater, a rod coater, a knife coater, a squeeze coater, a reverse roll coater and a bar coater. The extrusion die coater, curtain flow coater or bar coater is preferably used to prevent the coater from contacting with the already formed a first coating layer.

The coating amount of the second coating liquid is generally 5 to 50 g/m², and preferably 10 to 30 g/m².

After application of the second coating liquid, generally drying and curing is carried out at 40 to 180° C. for 0.5 to 30 minutes. Heating at a temperature of 40 to 150° C. for 1 to 20 minutes is preferable. For example, when borax or boric acid is included in the first coating liquid as a cross-linking agent, then carrying out heating to a temperature of 60 to 100° C. for 5 to 20 minutes is preferable.

When the basic liquid (second coating liquid) is applied simultaneously with applying the inc receiving layer coating liquid (first coating liquid), the first and second coating liquids are simultaneously provided on the support so that the first liquid contacts the support (multi-layer coating), and then the liquids are dried to thereby form the ink receiving layer.

Coating methods using, for example, an extrusion die coater or a curtain flow coater may be employed for simultaneous application (multilayer coating). When the coated layers are dried after the simultaneous coating, these layers are usually dried by heating at 40 to 150° C. for 0.5 to 10 minutes, and preferably by heating at 40 to 100° C. for 0.5 to 5 minutes.

When the coating liquids are simultaneously applied (multi-layer coating) using, for example, an extrusion die coater, the simultaneously supplied two coating liquids are laminated at near the outlet of the extrusion die coater, or immediately before the liquids are transferred onto the support, and are laminated on the support to make a dual layer. Since the two layers of the coating liquids laminate before application onto the support, they tend to undertake cross-linking at the interface between the two liquids while the liquids are transferred onto the support. This results in the supplied two liquids readily become viscous by being mixed with each other in the vicinity of an outlet of the extrusion die coater, occasionally leading to trouble in the coating operation. Accordingly, it is preferable to simultaneously arrange triple layers by presenting a barrier layer liquid (intermediate layer liquid) between the first coating liquid and the second coating liquid, at the same time as applying of the first and second coating liquids.

The barrier-layer liquid can be selected without particularly limitations, and examples thereof include an aqueous solution containing a trace amount of water-soluble resin, water, and the like. The water-soluble resins are used considering the coating property of the liquid for example, for increasing the viscosity of the liquid, and examples thereof are polymers including cellulosic resins (e.g., hydroxypropylmethylcellulose, methylcellulose, hydroxyethylmethyl cellulose, and the like), polyvinylpyrrolidone, gelatin, and the like. The barrier-layer liquid may also contain a mordant.

After forming on the support, the ink receiving layer may be subjected to calendering by passing through roll nips under heat and pressure, for example, by using a super calender or gloss calender, or the like, for improvement in the surface smoothness, glossiness, transparency, and strength of the coated film. However, because calendering sometimes causes decrease in void ratio (i.e., decrease in ink absorptive property), it is necessary carry out calendering under conditions set to reduce the decrease in void ratio.

The roll temperature during calendering is preferably 30 to 150° C. more preferably 40 to 100° C., and the linear pressure between rolls during calendering is preferably 50 to 400 kg/cm and more preferably 100 to 200 kg/cm.

The thickness of the ink receiving layer formed in the invention should be decided, in the case of inkjet recording, according to the void percentage of the layer, as the layer should have a sufficient absorption capacity allowing absorption of all droplets. For example, if the ink quantity is 8 nl/mm² and the void percentage is 60%, a film having a thickness of about 15 μm or more is required. Considering the above, ink receiving layer for ink jet recording preferably has a thickness of 10 to 50 μm.

In addition, the median diameter of the pores in the ink receiving layer is preferably 0.005 to 0.030 μm, and more preferably 0.01 to 0.025 μm. The void ratio and the pore median size may be determined by using a mercury porosimeter (trade name: “Poresizer 9320-PC2”, manufactured by Shimadzu Corporation).

The pH of the film surface of the ink-receiving layer formed in the invention is preferably in the range of 3 to 6, and more preferably in the range of 3 to 5 from the viewpoint of preventing the yellowing of the ink-receiving layer.

The film surface pH of the ink-receiving layer is adjusted, for example, by adding a known acid (e.g., hydrochloric acid, acetic acid, and nitric acid), a base (e.g., NaOH and ammonia), or a salt thereof (e.g., ammonium carbonate) to the coating liquid in advance, or by sequentially overcoating the formed ink-receiving layer.

In the invention, the film surface pH of the ink-receiving layer is measured 30 to 40 seconds after adding 50 μl of pure water having a pH of 6.2 to 7.2 dropwise onto the ink-receiving layer, according to the paper surface pH measurement as specified in J. TAPPI 49.

The ink absorption capacity (void capacity) of the ink-receiving layer is preferably 18 to 40 ml cm², and more preferably 20 to 30 ml/cm².

The ink receiving layer is preferably higher in transparency, and the haze value, an indicator of transparency, of the ink receiving layer formed on a transparent film support is preferably 30% or less and more preferably 20% or less. The haze value may be determined by using a hazemeter (trade name: HGM-2DP, manufactured by Suga Test Instrument Co., Ltd.).

Support and the Like

A transparent support made of a transparent material such as plastic, and opaque support composed of an opaque material such as paper can be used as a support which can be used for the invention. Especially, a transparent support or an opaque support having high glossiness is preferably used to make the best use of the transparency of the ink receiving layer.

Material which is transparent and can endure radiant heat when used on OHPs and backlight displays is preferable as a material which can be used for the above transparent support. Examples of the material include polyesters such as polyethylene terephthalate (PET); polysulfone, polyphenylene oxide, polyimide, polycarbonate and polyamide. The polyesters are preferable among them, and especially, polyethylene terephthalate is preferable.

The thickness of the transparent support is not particularly limited. However, a thickness of 50 to 200 μm is preferable in view of easy use.

An opaque support having high glossiness whose surface on which the ink receiving layer is formed has a glossiness degree of 40% or more is preferable. The glossiness degree is a value determined according to the method described in JIS P-8142 (paper and a paperboard 75 degree method for examining specular glossiness degree). Examples of such supports include the following supports.

Examples include paper supports having high glossiness such as art paper, coat paper, cast coat paper and baryta paper used for a support for a silver salt photography or the like; polyesters such as polyethylene terephthalate (PET), cellulose esters such as nitrocellulose, cellulose acetate and cellulose acetate butyrate, opaque high glossiness films which are constituted by incorporating white pigment or the like in plastic films such as polysulfone, polyphenylene oxide, polyimide, polycarbonate and polyamide (a surface calendar treatment may be performed); or, supports in which a coating layer made of polyolefin which either does or does not contain a white pigment is formed on the surface of a high glossiness film containing the various paper supports, transparent supports or white pigment or the like.

Also, white pigment-containing foam polyester film (for instance, a foam PET which contains the polyolefin fine particles, and contains voids formed by drawing out) is preferable. Further, a resin coated paper for silver halide salt photographic use is suitable.

The thickness of the opaque support is not particularly limited. However, a thickness of 50 to 300 μm is preferable in view of ease of handling.

One treated by corona discharge treatment, glow discharge treatment, flame treatment or ultraviolet radiation treatment or the like may be used for the surface of the support, so as to improve wetting and adhesion properties.

Next, base paper used for paper support, such as resin coated paper, will be described.

The base paper is mainly made of wood pulp, and is made by using a synthetic pulp, such as polypropylene, in addition to the wood pulp if necessary, or a synthetic fiber such as nylon or polyester. LBKP, LBSP, NBKP, NB SP, LDP, NDP, LUKP and NUKP can be used as the wood pulp. It is preferable to use more LBKP, NBSP, LBSP, NDP and LDP which contain a lot of short fibers. The ratio of LBSP and/or LDP is preferable in the range between 10% by mass and 70% by mass.

A chemical pulp with few impurities (sulfate pulp and sulfite pulp) is preferably used as the pulp, and a pulp in which whiteness is improved by bleaching, is useful.

Sizing agents such as higher fatty acid and alkyl ketene dimer, white pigments such as calcium carbonate, talc and titanium oxide, paper reinforcing agents such as starch, polyacrylamide and polyvinyl alcohol, optical brightening agents, water retention agents such as polyethylene glycols, dispersing agents, and softening agents such as a quaternary ammonium can be appropriately added to the base paper.

The freeness of pulp used for papermaking is preferably 200 to 500 ml as stipulated in CSF. The sum of 24 mesh remainder portions and 42 mesh remainder portions after beating is preferably 30 to 70% by mass as stipulated in JIS P-8207. 4 mesh remainder portion is preferably 20% by mass.

The basis weight of the base paper is preferably 30 to 250 g, and more preferably 50 to 200 g. The thickness of the base paper is preferably 40 to 250 μm. High smoothness can be imparted to the base paper by calendar treatment at the making paper step or after paper making. The density of the base paper is generally 0.7 to 1.2 g/m² (JIS P-8118). In addition, the rigidity of the base paper is preferably 20 to 200 g under the conditions of JIS P-8143.

A surface size agent may be coated on the surface of the base paper, and a size agent which is the same as size which can be added to the base paper can be used as the surface size agent.

It is preferable that the pH of the base paper is 5 to 9 when measured by a hot water extraction method provided by JIS P-8113.

In general, the both front and back surfaces of the base paper can be coated with polyethylene. Main examples of polyethylenes include low density polyethylene (LDPE) and/or high density polyethylene (HDPE) but others such as LLDPE and polypropylene can be also used in part.

Especially, in the polyethylene layer on the side on which the ink receiving layer is formed, it is preferable that rutile type or anatase type titanium oxide, an optical brightening agent or ultramarine blue pigment are added to polyethylene, and thereby the degree of opaqueness, whiteness and color are improved, as is widely performed for printing papers for photographs. Herein, the content of titanium oxide is preferably about 3 to 20% by mass, and more preferably 4 to 13% by mass to polyethylene. The thickness of the polyethylene layer is not limited to a particular thickness, and more preferably 10 to 50 μm for both layers. Further, an undercoat layer can be formed to give adhesion of the ink receiving layer on the polyethylene layer. Water polyester, gelatin, and PVA are preferably used as the undercoat layer. The thickness of the undercoat layer is preferably 0.01 to 5 μm.

A polyethylene coated paper sheet may be used as glossy paper, or when polyethylene is coated on the surface of the base paper sheet by melt-extrusion a matte surface or silk finish surface may be formed by applying an embossing treatment, as obtainable in usual photographic printing paper sheets.

On the support body a back coat layer can be provided, and white pigments, water soluble binders and other components can be used as additive components of the back coat layer.

Examples of the white pigment contained in the back coat layer include inorganic white pigments such as calcium carbonate light, calcium carbonate heavy, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate and magnesium hydroxide; and organic pigments such as styrene plastic pigments, acrylic plastic pigments, polyethylene, microcapsules, urea resin and melamine resin.

Examples of the aqueous binders used for the back coat layer include water soluble polymers such as styrene/maleic acid copolymer, styrene/acrylate copolymer, polyvinyl alcohol, silanol modified polyvinyl alcohol, starch, cationic starch, casein, gelatin, carboxymethyl cellulose, hydroxyethyl cellulose and polyvinyl pyrrolidone; and water dispersible polymers such as styrene-butadiene latex and acrylic emulsion.

Other components contained in the back coat layer include defoaming agents, foaming suppressing agents, dyes, optical brighteners, preservatives and water-proofing agents.

As described above, according to the invention, it is possible to obtain an ink jet recording medium, which improves the ink absorptive property and produces an excellent coated surface condition. In addition, when the ink-receiving layer contain gas phase method silica and has a three-dimensional network structure with a void ratio of 50 to 80%, it is also possible to achieve excellent ink-receiving performance, for example, the favorable ink absorptive property is further improved to form a high-resolution and high-density image, and bleeding over time in a high temperature and high humidity environment is prevented to form an image with high resistance against light and moisture.

Furthermore, the ink jet recording medium obtained by the invention can exhibit a glossiness of 30% or more at 60°. The glossiness can be measured with a digital bending gloss meter (trade name: UGV-50DP, manufactured by Suga Test Instrument Co., Ltd.) or the like.

Ink Jet Recording Method

The ink jet recording method of the invention includes forming an image using the above-described ink jet recording set.

It is possible to obtain recorded matter having extremely favorable ozone resistance by forming an image by the ink jet recording method of the invention using the ink jet recording set of the invention (the above-described ink jet recording medium and the above-described ink). The term recorded matter refers to an ink jet recording medium on which an image or letters have been recorded.

In the ink jet recording method of the invention, the ink jet recording method is not limited, and known methods can be used, for example, a charge controlling method of jetting ink using electrostatic attraction, a drop on demand method (pressure pulse method) of using vibratory pressure, an acoustic ink jet method of jetting ink droplets using the radiation pressure applied onto the ink by acoustic beam converted from an electric signal, and a thermal ink jet method of using pressure generated by bubbles formed in the ink by heating. The ink jet recording method include a method of jetting many droplets of a low concentration ink, which is referred to as photo ink, at a small volume, a method of improving the image quality using a plurality of inks having substantially the same hue and different density, and a method of using a colorless and transparent ink.

The disclosure of Japanese Patent Application No. 2006-26376 is incorporated herein by reference in its entirety.

In the following, exemplary embodiments of the invention will be described. However the invention is not limited these exemplary embodiments.

[1] An ink jet recording set comprising: an ink jet recording medium comprising a water-soluble aluminum compound and a sulfoxide compound in an ink-receiving layer on a support; and an ink containing a dye represented by the following formula (1):

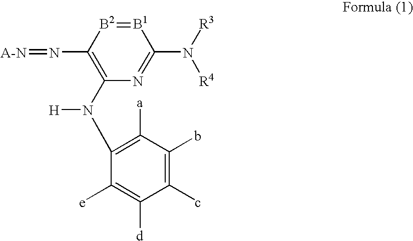

wherein in formula (1), A represents a 5-membered heterocyclic group; B¹ and B² each represent —CR¹═ and —CR²═, or one represents a nitrogen atom, and the other represents —CR¹═ or —CR²═; R³ and R⁴ each independently represent a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group, or a sulfamoyl group; R¹ and R² each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclic amino group, an acylamino group, an ureido group, a sulfamoylamino group, an alkoxycarbonylamino group, an aryloxycarbonyl amino group, an alkylsulfonyl amino group, an arylsulfonyl amino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group; R¹ and R² may be bonded to each other to form a 5- or 6-membered ring; R³ and R⁴ may be bonded to each other to form a 5- or 6-membered ring; a and e each independently represents an alkyl group, an alkoxy group, or a halogen atom; when a and e are each an alkyl group, the alkyl groups have 3 or more carbons in total, and they may be further substituted; b, c, and d each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclic amino group, an acylamino group, an ureido group, a sulfamoylamino group, an alkoxycarbonylamino group, an aryloxycarbonyl amino group, an alkylsulfonyl amino group, an arylsulfonyl amino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group; a and b may be fused with each other to form a ring; e and d may be fused with each other to form a ring; and formula (1) has at least one ionic hydrophilic group.

[2] The ink jet recording set as described in [1], wherein the dye represented by formula (1) is also represented by the following formula (2):

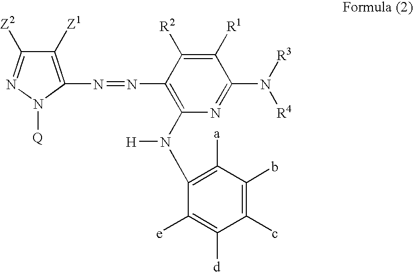

wherein in formula (2), Z¹ represents an electron-withdrawing group having a Hammett's substituent constant up value of 0.20 or more; Z² represents a hydrogen atom, an aliphatic group, an aromatic group, or a heterocyclic group; Q represents a hydrogen atom, an aliphatic group, an aromatic group, or a heterocyclic group; R³ and R⁴ each independently represent a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group, or a sulfamoyl group; R¹ and R² each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclicamino group, an acylamino group, an ureido group, a sulfamoylamino group, an alkoxycarbonylamino group, an aryloxycarbonylamino group, an alkylsulfonylamino group, an aryl sulfonylamino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group; R¹ and R² may be bonded to each other to form a 5-membered or 6-membered ring; R³ and R⁴ may be bonded to each other to form a 5-membered or 6-membered ring; a and e each independently represent an alkyl group, an alkoxy group, or a halogen atom; when both a and e are each an alkyl group, the alkyl groups have 3 or more carbon atoms in total, and they may be further substituted; b, c, and d each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclic amino group, an acylamino group, an ureido group, a sulfamoylamino group, an alkoxycarbonylamino group, an aryloxycarbonyl amino group, an alkylsulfonyl amino group, an arylsulfonyl amino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group; a and b may be fused with each other to form a ring; e and d may be fused with each other to form a ring; and formula (2) has at least one ionic hydrophilic group.

[3] The ink jet recording set of as described in [1], wherein the aluminum compound is a polyaluminum chloride.

[4] The ink jet recording set of as described in [1], wherein the sulfoxide compound includes, in its molecule, one or more structures represented by the following formula (S1):

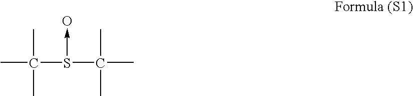

[5] The ink jet recording set as described in [1], wherein in formula (1), A represents a pyrazole ring, an imidazole ring, an isothiazole ring, a thiadiazole ring, or a benzothiazole ring; B¹ represents an unsubstituted carbon atom and B² represents an unsubstituted or alkyl substituted carbon atom; R³ and R⁴ each independently represent a hydrogen atom, an alkyl group, an aralkyl group, an aryl group, a heterocyclic group, a sulfonyl group, or an acyl group; and a and e each independently represent an alkyl group or a halogen atom; when a and e are each an alkyl group, they are unsubstituted alkyl groups and the total of the carbon atoms of a and e is 3 or more; and b, c, and d each independently represent a hydrogen atom, a halogen atom, an alkyl group, or an ionic hydrophilic group.

[6] The ink jet recording set as described in [1], wherein the content of the sulfoxide compound of the ink jet recording medium is 0.01 to 20 g/m².

[7] An ink jet recording method comprising forming an image using the ink jet recording as described in [1].

[8] The ink jet recording method as described in [7], wherein the dye represented by the above-described formula (1) is also represented by the following formula (2):

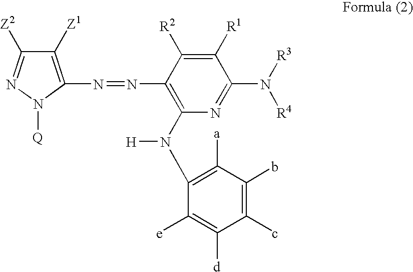

wherein in formula (2), Z¹ represents an electron-withdrawing group having a Hammett's substituent constant σp value of 0.20 or more; Z² represents a hydrogen atom, an aliphatic group, an aromatic group, or a heterocyclic group; Q represents a hydrogen atom, an aliphatic group, an aromatic group, or a heterocyclic group; R³ and R⁴ each independently represent a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group, or a sulfamoyl group; R¹ and R² each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclicamino group, an acylamino group, an ureido group, a sulfamoylamino group, an alkoxycarbonylamino group, an aryloxycarbonylamino group, an alkylsulfonylamino group, an aryl sulfonylamino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group; R¹ and R² may be bonded to each other to form a 5-membered or 6-membered ring; R³ and R⁴ may be bonded to each other to form a 5-membered or 6-membered ring; a and e each independently represent an alkyl group, an alkoxy group, or a halogen atom; when both a and e are each an alkyl group, the alkyl groups have 3 or more carbon atoms in total, and they may be further substituted; b, c, and d each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclic amino group, an acylamino group, an ureido group, a sulfamoylamino group, an alkoxycarbonylamino group, an aryloxycarbonyl amino group, an alkylsulfonyl amino group, an arylsulfonyl amino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group; a and b may be fused with each other to form a ring; e and d may be fused with each other to form a ring; and formula (2) has at least one ionic hydrophilic group.

[9] The ink jet recording method as described in [7], wherein the water-soluble aluminum compound is a polyaluminum chloride.

[10] The ink jet recording method as described in [7], wherein the sulfoxide compound includes, in its molecule, one or more structures represented by the following formula (S1):

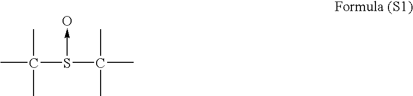

### EXAMPLES

The present invention is further illustrated by following Examples, however the invention is not limited to them. In the Examples, an ink jet recording sheet is prepared as an example of the ink jet recording medium, and “parts” and “%” in the Examples are based on mass unless otherwise specified.

[Preparation of Ink Jet Recording Medium 1]

(Preparation of Support)

50 parts of acacia LBKP and 50 parts of aspen LBKP were respectively beaten with a disc refiner to a Canadian freeness of 300 ml, and a pulp slurry was prepared.

Subsequently, to the pulp slurry obtained as described above, with reference to the pulp, 1.3% of cationic starch (trade name: CAT 0304L, manufactured by Japan NSC), 0.15% of anionic polyacrylamide (trade name: POLYACRON ST-13, manufactured by Seiko Chemical Co.), 0.29% of an alkylketene dimmer (trade name: SIZEPINE K, manufactured by Arakawa Chemical Industries, Ltd.), 0.29% of epoxidized behenic acid amide, 0.32% of polyamide polyamine epichlorohydrin (trade name: ARAFIX 100, manufactured by Arakawa Chemical Industries, Ltd.), were added, and then 0.12% of an antifoaming agent was added.

The pulp slurry prepared as described above was used for papermaking with a fourdrinier machine, and the resulting web was dried by pressing the felt surface of the web against the drum dryer cylinder via a dryer canvas with the tensile strength of the dryer canvas set at 1.6 kg/cm. Subsequently polyvinyl alcohol (trade name: KL-118, manufactured by Kuraray Co., Ltd.) was applied to both the surfaces of the base paper in an amount of 1 g/m², dried. Then, a calendering treatment was carried out. The raw paper (base paper) was produced at a basis weight of 166 g/m² and a thickness of 160 μm.

The wire surface (back surface) of the obtained base paper was subjected to corona discharge treatment, and coated with high-density polyethylene at a thickness of 25 μm using a melt-processing extruder to form a thermoplastic resin layer having a matte surface. (Hereinafter the thermoplastic resin layer surface is referred to as “back surface”.) The thermoplastic resin layer on the back surface side was further subjected to corona discharge treatment, and then coated with, as an anti-static agent, a dispersion liquid, in which aluminum oxide (trade name: ALUMINA SOL 100, manufactured by Nissan Chemical Industries, Ltd.) and silicon dioxide (trade name: SNOWTEX O, manufactured by Nissan Chemical Industries, Ltd.) had been dispersed in water at a mass ratio of 1:2, in a dry mass of 0.2 g/m². Subsequently the front surface was subjected to corona treatment, and coated with polyethylene having a density of 0.93 g/m² and containing 10% by mass of titanium oxide with a melt-processing extruder in an amount of 24 g/m².

<Preparation of Silica Dispersion Liquid>

(1) Gas phase method silica fine particles, (2) ion exchanged water, (3) SHAROLL DC-902P, and (4) ZA-30 as shown in the following composition were mixed, and dispersed with a bead mill (e.g., trade name: KD-P, manufactured by Shinmaru Enterprises Corporation). Subsequently, the dispersion liquid was heated to 45° C., kept at the temperature for 20 hours, thus a silica dispersion liquid was obtained.

| | | |
|---|---|---|
| (1) | Gas phase method silica fine particles | 15.0 parts |
| | (AEROSIL 300SF75, manufactured by | |
| | Nippon Aerosil Co., Ltd.) | |
| (2) | Ion exchanged water | 82.9 parts |
| (3) | SHAROLL DC-902P (51.5% aqueous solution) | 1.31 parts |
| | (Dispersant, manufactured by Dai-Ichi Kogyo | |
| | Seiyaku Co., Ltd.) | |
| (4) | ZA-30 (zirconyl acetate) | 0.8 parts |
| | (manufactured by Daiichi Kigenso Kagaku | |
| | Kogyo Co., Ltd.) | |

### <Preparation of Ink-Receiving Layer Coating Liquid A (First Liquid)>

To 59.5 parts of the above-described silica dispersion liquid, the following ingredients were added at 30° C., thus the ink-receiving layer coating liquid A (first liquid) was prepared.

<Composition of ink-receiving layer coating liquid A>

| | The above-described silica dispersion liquid | 59.5 parts |
|---|---|---|
| (5) | Diethylene glycol monobutyl ether | 0.15 parts |
| | (trade name: BUTYCENOL 20P, manufactured | |
| | by Kyowa Hakko Chemical Co., Ltd.) | |
| (6) | Boric acid (cross-linking agent) | 0.3 parts |
| (7) | Dimethylamine-epichlorohydrin-polyalkylene | 0.2 parts |
| | polyamine polycondensate (trade name: SC-505, | |
| | manufactured by HYMO Co.,Ltd.) (50% aqueous | |
| | solution) | |
| (8) | Polyvinyl alcohol (water-soluble resin) solution | 26.0 parts |
| | (Composition of solution) | |
| | PVA235, saponification degree 88%, polymerization | 1.8 parts |
| | degree 3500, manufactured by Kuraray Co., Ltd. | |
| | EMULGEN 109P | 0.06 parts |
| | (Polyoxyethylene lauryl ether (surfactant), | |
| | manufactured by Kao Corporation) | |
| | Ion exchanged water | 23.8 parts |
| (9) | SUPERFLEX 600 (manufactured by Dai-Ichi | 1.1 parts |
| | Seiyaku Kogyo Co., Ltd.) | |
| (10) | Synthetic alcohol (trade name: AP-7, manufactured | 2.3 parts |
| | by Japan Alcohol Trading Co., Ltd.) | |
| (11) | Ion exchanged water | 10.45 parts |

[Preparation of Ink Jet Recording Medium]

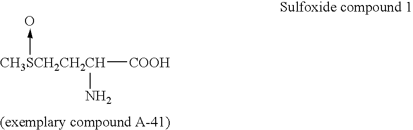

[Preparation of Ink Jet Recording Medium 3]

The ink jet recording medium 3 was prepared in the same manner as the ink jet recording medium 1, except that in the preparation of the silica dispersion liquid, the amount of SHAROLL DC-902P was changed to 0.87 parts and the amount of (2) ion exchanged water was changed to 83.3 parts; in the preparation of the ink-receiving layer coating liquid A, the amount of the silica dispersion liquid was changed to 58.7 parts, 1 part of the above-described sulfoxide compound I (exemplary compound A-41) was added, (9) SUPERFLEX 600 was not added, and the amount of (11) ion exchanged water was changed to 11. 35 parts; and in the preparation of the basic aqueous solution B, (2) zirconium ammonium carbonate was removed, and the amount of ion exchanged water was changed to 64.35 parts.

[Magenta Ink Liquid 1]

Components having the composition described below were dissolved by stirring for 1 hour while the mixture was heated at 30 to 40° C. Subsequently, the mixture was filtered through a microfilter having an average pore diameter of 0.2 μm under reduced pressure, and water was added to make the whole 500 parts, thus the magenta ink liquid 1 was obtained.

<Composition of magenta ink liquid 1>

| | |
|---|---|
| Dye-M1 | 17.5 parts |
| Glycerol | 51 parts |
| Triethylene glycol | 9.5 parts |
| Triethyleneglycol monobutyl ether | 52 parts |
| 1,2-hexanediol | 6 parts |
| 2-pyrrolidone | 5.5 parts |
| Urea | 12 parts |
| Triethanolamine | 1 part |
| PROXEL XLII | 0.5 parts |
| (anti-fungus agent, manufactured by Avecia Limited.) | |
| Additive 1 | 8.8 parts |

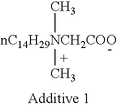

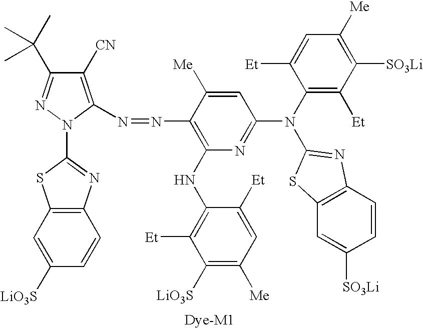

[Preparation of Magenta Ink Liquid 2]

The magenta ink liquid 2 was prepared in the same manner as the above-described magenta ink liquid 1, except that dye-M1 was replaced with dye-M2.

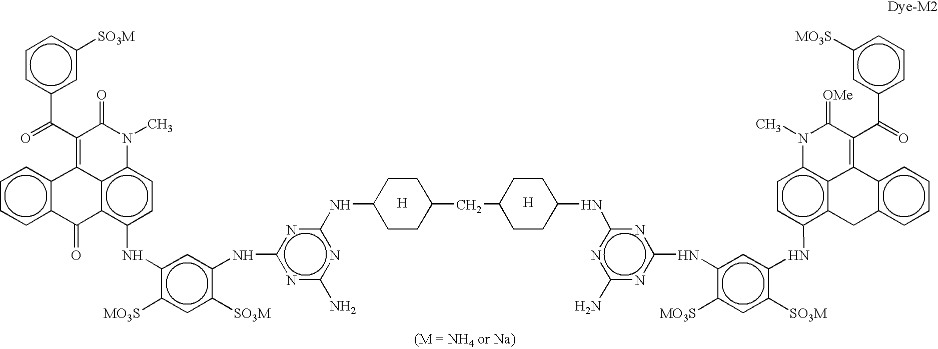

[Preparation of Magenta Ink Liquids 3-7]

The magenta ink liquids 3 to 7 were prepared in the same manner as the above-described magenta ink liquid 1, except that dye-M1 was replaced with the dyes listed in Table 7.

### Comparative Example 1

The recorded matter 1 was prepared from the ink jet recording set listed in Table 7 (magenta ink liquid 1 and ink jet recording medium 1) using an ink jet printer (trade name: PMA-700, manufactured by Epson Corporation), in such a manner that the reflection density of the recorded image became 1.0.

### Example 1 and 2, 3 to 7, and Comparative Examples 2 to 4

The recorded matters 2 to 11 were prepared in the same manner as Comparative Example 1, except that the magenta ink liquid 1 and the ink jet recording medium 1 were replaced with the magenta ink liquid and the ink jet recording medium listed in Table 7.

[Evaluation]

<Ozone resistance>

The recorded matter obtained as described above was stored for 168 hours at 23° C., 60% RH, in a dark room, and an atmosphere containing ozone at 5 ppm. Ozone resistance was evaluated by the residual ratio of the magenta density after storage relative to the density before storage, according to the following evaluation criteria.

(Residual Ratio of Magenta Density)

A: 75% or more

B: 70% or more and less than 75%

C: 65% or more and less than 70%

D: 60% or more and less than 65%

E: 55% or more and less than 60%

F: Less than 55%

<Hue Change>

The hue change was evaluated as follows by the change of the center wavelength of the half value width of the reflection spectrum before and after storage (ozone treatment) of the recorded matters obtained as described above.

(Hue Change)

A: Less than 1 nm

B: 1 nm or more and less than 3 nm

C: 3 nm or more

TABLE 7

| | | Recording | Magenta | | Magenta density | Hue |
|---|---|---|---|---|---|---|
| | Sample | medium | ink liquid | Dye | residual ratio | change |
| Comparative | Recorded | 1 | 1 | Dye-M1 | E | C |
| Example 1 | matter 1 | | | | | |
| Example 1 | Recorded | 2 | 1 | Dye-M1 | B | B |
| | matter 2 | | | | | |
| Example 2 | Recorded | 3 | 1 | Dye-M1 | A | A |
| | matter 3 | | | | | |
| Comparative | Recorded | 1 | 2 | Dye-M2 | F | A |
| Example 2 | matter 4 | | | | | |
| Comparative | Recorded | 2 | 2 | Dye-M2 | E | A |
| Example 3 | matter 5 | | | | | |
| Comparative | Recorded | 3 | 2 | Dye-M2 | C | A |
| Example 4 | matter 6 | | | | | |
| Example 3 | Recorded | 3 | 3 | a-3 (Na salt) | A | A |
| | matter 7 | | | | | |
| Example 4 | Recorded | 3 | 4 | b-5 (K salt) | A | A |
| | matter 8 | | | | | |
| Example 5 | Recorded | 3 | 5 | c-2 (Li salt) | A | A |
| | matter 9 | | | | | |
| Example 6 | Recorded | 3 | 6 | d-2 (Na salt) | A | A |
| | matter 10 | | | | | |
| Example 7 | Recorded | 3 | 7 | d-4 (Li salt) | A | A |
| | matter 11 | | | | | |

As apparent from Table 7, the magenta density residual ratio was 70% or more in Examples in which both the magenta ink liquid and the recording medium in the invention was used, indicating good ozone resistance. On the other hand, the magenta density residual ratio was less than 70% in all Comparative Examples, indicating poor ozone resistance.

[Preparation of Yellow Ink Liquid 1]

The yellow ink liquid 1 was prepared in the same manner as the above-described magenta ink liquid 1, except that the composition of the magenta ink liquid 1 was changed to the following composition of the yellow ink liquid 1.

<Composition of yellow ink liquid 1>

| | |
|---|---|
| Dye-Y1 | 25 parts |
| Glycerol | 59 parts |
| Triethylene glycol | 48 parts |
| Triethylene glycol monobutyl ether | 51 parts |
| Urea | 10 parts |
| Triethanolamine | 0.5 parts |
| PROXEL XLII | 0.5 parts |
| (anti-fungus agent, manufactured by Avecia Limited.) | |
| OLFIN E1010 | 5 parts |
| (surfactant, manufactured by Nisshin Chemical Industry Co.) | |

Dye-Y1

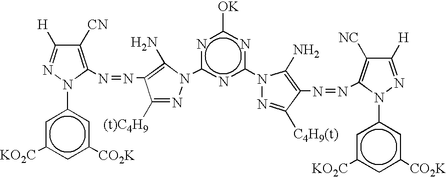

[Preparation of Yellow Ink Liquid 2]

The yellow ink liquid 2 was prepared in the same manner as the above-described yellow ink liquid 1, except that dye-Y1 was replaced with a mixture of 2.1 parts of dye-Y2, 2.1 parts of dye-Y3, and 0.7 parts of dye 4 which are described below.

Dye-Y2: C. I. Direct Yellow 132

Dye-Y3: C. I. Direct Yellow 86

Dye-Y4: C. I. Direct Yellow 58

[Preparation of Yellow Ink Liquids 3 to 5]

The yellow ink liquids 3 to 5 were prepared in the same manner as the above-described yellow ink liquid 1, except that dye-Y1 was replaced with DYE-8 (Li salt), DYE-9 (Li salt), or DYE-10 (K salt), which are shown below.

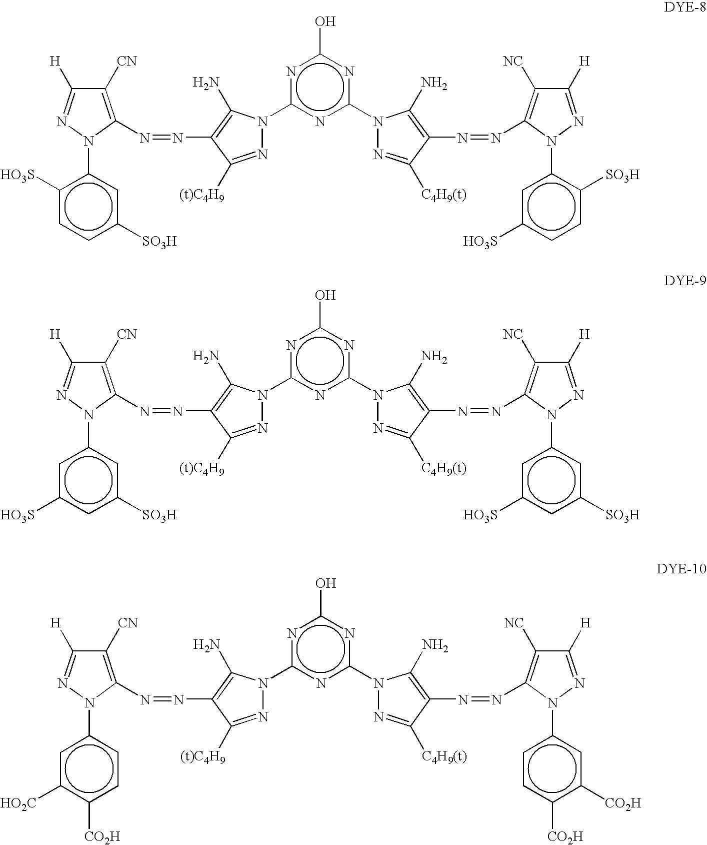

[Preparation of Cyan Ink Liquid 1]

The cyan ink liquid 1 was prepared in the same manner as the above-described magenta ink liquid 1, except that the composition of the magenta ink liquid 1 was changed to the following composition of the cyan ink liquid 1, and that water was added to make the whole not 500 parts but 100 parts.

<Composition of cyan ink liquid 1>

| | |
|---|---|
| Dye-C1 | 4.7 parts |
| Urea | 2.4 parts |
| Triethylene glycol | 10.7 parts |
| Triethylene glycol monobutyl ether | 9.1 parts |
| 1,2-hexanediol | 2.4 parts |
| 2-pyrrolidone | 3.5 parts |
| Glycerol 1 | 1.8 parts |
| Triethanolamine | 0.5 parts |
| PROXEL XLII | 1.0 part |
| (anti-fungus agent, manufactured by Avecia Limited.) | |
| OLFIN E1010 | 1.0 part |
| (surfactant, manufactured by Nisshin Chemical Industry Co.) | |

Dye-C1

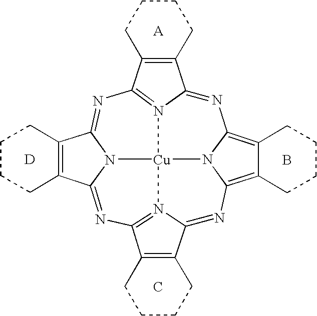

One of rings A to D is

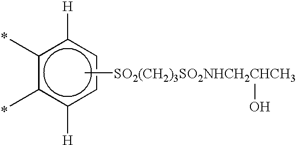

Other 3 rings are each

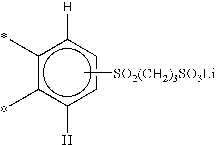

* denotes a binding position of the phthalocyanin ring

[Preparation of Cyan Ink Liquids 2 to 4]

The cyan ink liquids 2 to 4 were prepared in the same manner as the above-described magenta ink liquid 1, except that dye-C1 was replaced with the following dye-C2, C3, or C4.

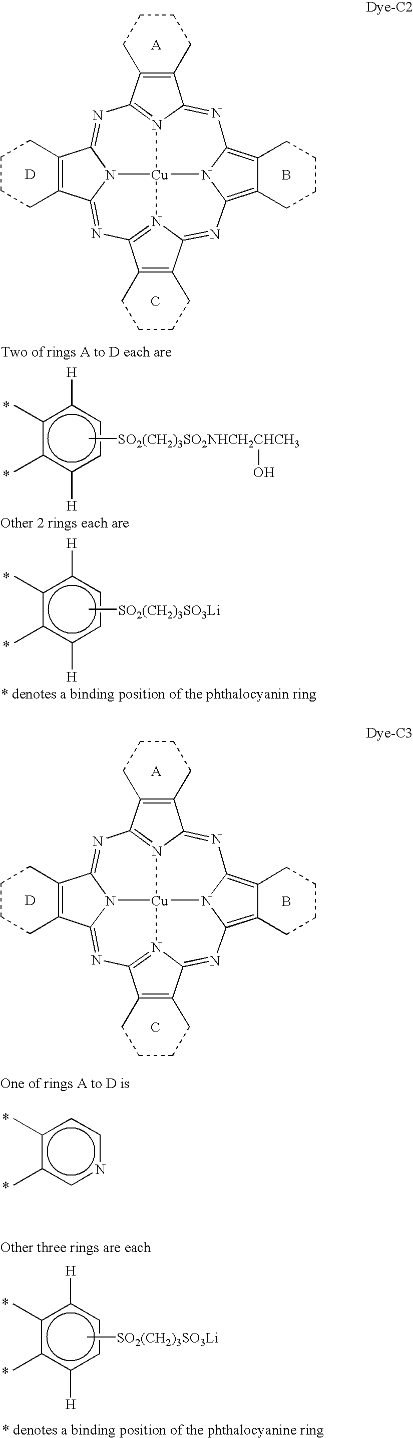

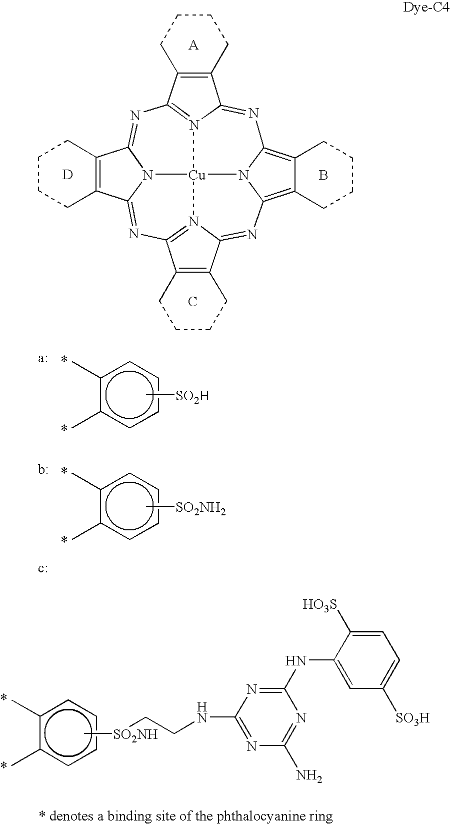

Mixture of the following compounds of I to III

c=0, a+b=4 I.

c=1, a+b=3 II.

c=2, a+b=2 III.

[Preparation of Cyan Ink Liquid 5]

The cyan ink liquid 5 was prepared in the same manner as the above-described cyan ink liquid 1, except that dye-C1 was replaced with C. I. Direct Blue-199.

[Preparation of Black Ink Liquid 1]

The black ink liquid 1 was prepared in the same manner as the above-described magenta ink liquid 1, except that the composition of the magenta ink liquid 1 was replaced with the following composition of the black ink liquid 1.

<Composition of black ink liquid 1>

| | |
|---|---|
| Dye-Bk1 | 30 parts |
| Dye-Bk2 | 7.5 parts |
| Urea | 45.0 parts |
| Triethylene glycol | 11.5 parts |
| Triethylene glycol monobuthylether | 40.0 parts |
| 1,2-hexanediol | 17.0 parts |
| 2-pyrrolidone | 17.0 parts |
| Glycerol | 50.0 parts |
| Triethanolamine | 2.0 parts |
| PROXEL XLII | 2.0 parts |
| (anti-fungus agent, manufactured by Avecia Limited.) | |
| OLFIN E1010 | 5.0 parts |
| (surfactant, manufactured by Nisshin Chemical Industry Co.) | |

Dye-Bk1

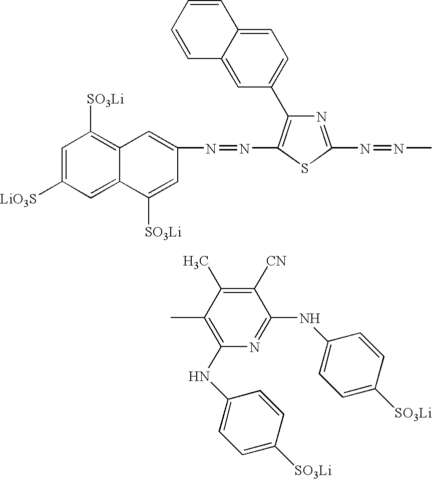

Dye-Bk2

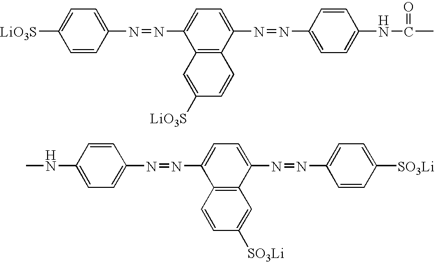

### [Preparation of Black Ink Liquids 2 to 4]

The black ink liquids 2 to 4 were prepared in the same manner as the above-described black ink liquid 1, except that dye-Bk1 was replaced with dye-Bk3 to dye-Bk5 shown below.

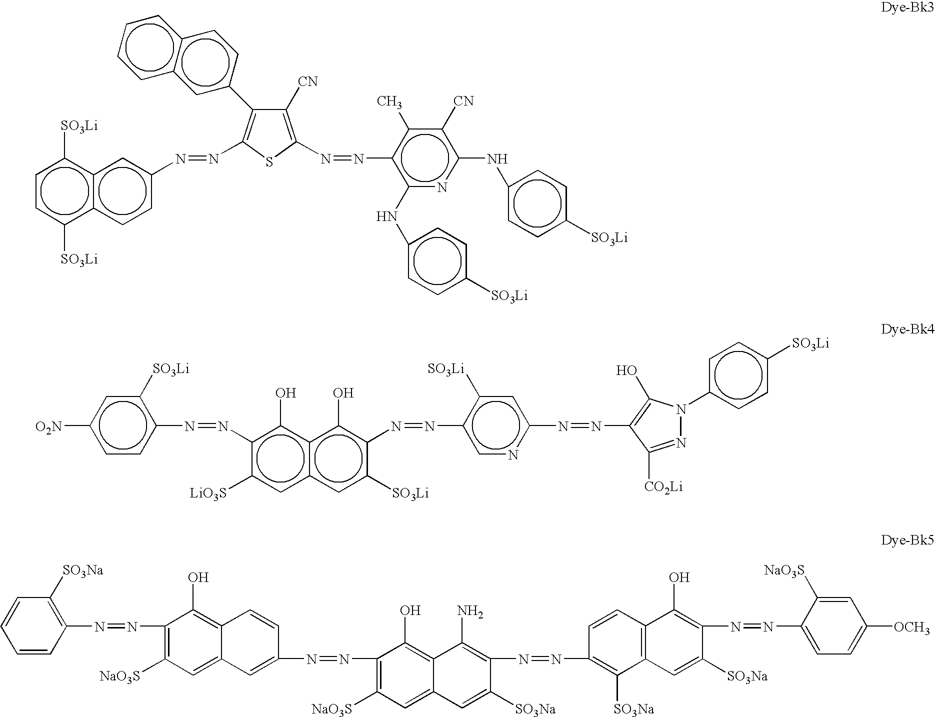

[Preparation of Black Ink Liquid 5]

The black ink liquid 5 was prepared in the same manner as the above-described black ink liquid 1, except that dye-Bk1 was replaced with dye-Bk6 shown below and dye-Bk2 was replaced with dye-Bk7.

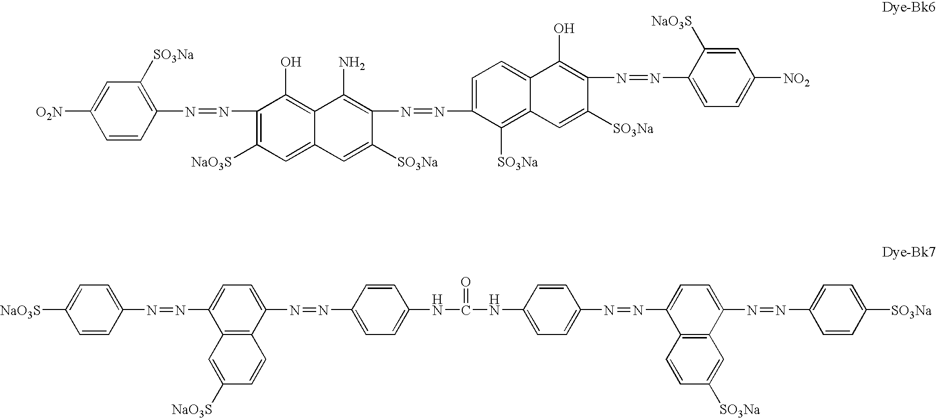

### Comparative Examples 5 to 6, Examples 8 to 12

Full color ink jet recorded matters were prepared and evaluated in the same manner as Comparative Example 1, using the ink jet recording sets listed in Table 8 comprising the combinations of the magenta ink liquids 1 to 3, yellow ink liquids 1 to 5, cyan ink liquids 1 to 5, black ink liquids 1 to 5 prepared as described above. The obtained results are shown below.

TABLE 8

| | | | | Yellow | | | Magenta | |
|---|---|---|---|---|---|---|---|---|
| | | Recording | Magenta | ink | Cyan ink | Black ink | density | Hue |
| | Sample | medium | ink liquid | liquid | liquid | liquid | residual ratio | change |
| Comparative | Recorded | 1 | 1 | 1 | 1 | 1 | E | C |
| Example 5 | matter 12 | | | | | | | |
| Example 8 | Recorded | 3 | 1 | 1 | 1 | 1 | A | A |
| | matter 13 | | | | | | | |
| Comparative | Recorded | 3 | 2 | 1 | 1 | 1 | C | F |
| Example 6 | matter 14 | | | | | | | |
| Example 9 | Recorded | 3 | 2 | 2 | 2 | 2 | A | A |
| | matter 15 | | | | | | | |
| Example 10 | Recorded | 2 | 2 | 3 | 3 | 3 | A | A |
| | matter 16 | | | | | | | |
| Example 11 | Recorded | 3 | 2 | 4 | 4 | 4 | A | A |
| | matter 17 | | | | | | | |
| Example 12 | Recorded | 3 | 3 | 5 | 5 | 5 | A | A |
| | matter 18 | | | | | | | |

As apparent from Table 8, the ozone resistance of the magenta printed area was favorable and not deteriorated on the full color images printed using the combinations of the above-described yellow, cyan, and black ink liquids and the magenta ink liquid in the invention.

According to the invention, an ink jet recording set, which is capable of forming an image with excellent ozone resistance, is provided. Furthermore, according to the invention, an ink jet recording method, which is capable of forming an image with excellent ozone resistance using the above-described ink jet recording set, is provided.

All publications, patent applications, and technical standards mentioned in this specification are herein incorporated by reference to the same extent as if each individual publication, patent application, or technical standard was specifically and individually indicated to be incorporated by reference.

1. An ink jet recording set comprising: an ink jet recording medium comprising a water-soluble aluminum compound and a sulfoxide compound in an ink-receiving layer on a support; and an ink containing a dye represented by the following formula (1): 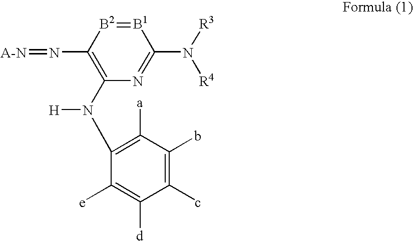
wherein in formula (1), A represents a 5-membered heterocyclic group; B¹ and B² each represent —CR¹═ and —CR²═, or one represents a nitrogen atom, and the other represents —CR¹═ or —CR²═; R³ and R⁴ each independently represent a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group, or a sulfamoyl group; R¹ and R² each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclic amino group, an acylamino group, an ureido group, a sulfamoylamino group, an alkoxycarbonylamino group, an aryloxycarbonyl amino group, an alkylsulfonyl amino group, an arylsulfonyl amino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group; R¹ and R² may be bonded to each other to form a 5- or 6-membered ring; R³ and R⁴ may be bonded to each other to form a 5- or 6-membered ring; a and e each independently represents an alkyl group, an alkoxy group, or a halogen atom; when a and e are each an alkyl group, the alkyl groups have 3 or more carbons in total, and they may be further substituted; b, c, and d each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclic amino group, an acylamino group, an ureido group, a sulfamoylamino group, an alkoxycarbonylamino group, an aryloxycarbonyl amino group, an alkylsulfonyl amino group, an arylsulfonyl amino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group; a and b may be fused with each other to form a ring; e and d may be fused with each other to form a ring; and formula (1) has at least one ionic hydrophilic group.

2. The ink jet recording set of claim 1, wherein the dye represented by formula (1) is also represented by the following formula (2): 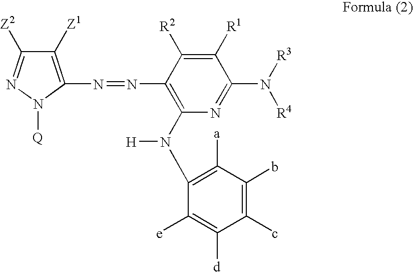
wherein in formula (2), Z¹ represents an electron-withdrawing group having a Hammett's substituent constant op value of 0.20 or more; Z² represents a hydrogen atom, an aliphatic group, an aromatic group, or a heterocyclic group; Q represents a hydrogen atom, an aliphatic group, an aromatic group, or a heterocyclic group; R³ and R⁴ each independently represent a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group, or a sulfamoyl group; R¹ and R² each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclicamino group, an acylamino group, an ureido group, a sulfamoylamino group, an alkoxycarbonylamino group, an aryloxycarbonylamino group, an alkylsulfonylamino group, an aryl sulfonylamino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group; R¹ and R² may be bonded to each other to form a 5-membered or 6-membered ring; R³ and R⁴ may be bonded to each other to form a 5-membered or 6-membered ring; a and e each independently represent an alkyl group, an alkoxy group, or a halogen atom; when both a and e are each an alkyl group, the alkyl groups have 3 or more carbon atoms in total, and they may be further substituted; b, c, and d each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclic amino group, an acylamino group, an ureido group, a sulfamoylamino group, an alkoxycarbonylamino group, an aryloxycarbonyl amino group, an alkylsulfonyl amino group, an arylsulfonyl amino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group; a and b may be fused with each other to form a ring; e and d may be fused with each other to form a ring; and formula (2) has at least one ionic hydrophilic group.

3. The ink jet recording set of claim 1, wherein the aluminum compound is a polyaluminum chloride.

4. The ink jet recording set of claim 1, wherein the sulfoxide compound includes, in its molecule, one or more structures represented by the following formula (S1):

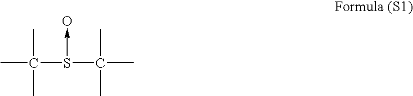

5. The ink jet recording set of claim 1, wherein in formula (1), A represents a pyrazole ring, an imidazole ring, an isothiazole ring, a thiadiazole ring, or a benzothiazole ring; B¹ represents an unsubstituted carbon atom and B² represents an unsubstituted or alkyl substituted carbon atom; R³ and R⁴ each independently represent a hydrogen atom, an alkyl group, an aralkyl group, an aryl group, a heterocyclic group, a sulfonyl group, or an acyl group; and a and e each independently represent an alkyl group or a halogen atom; when a and e are each an alkyl group, they are unsubstituted alkyl groups and the total of the carbon atoms of a and e is 3 or more; and b, c, and d each independently represent a hydrogen atom, a halogen atom, an alkyl group, or an ionic hydrophilic group.

6. The ink jet recording set of claim 1, wherein the content of the sulfoxide compound of the ink jet recording medium is 0.01 to 20 g/m².

7. An ink jet recording method comprising forming an image using the ink jet recording set of claim 1.

8. The ink jet recording method of claim 7, wherein the dye represented by the above-described formula (1) is also represented by the following formula (2): 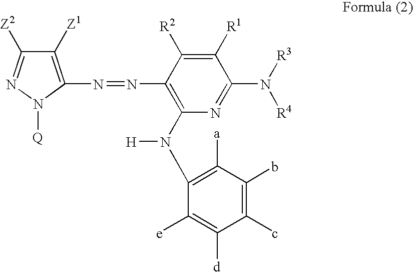
wherein in formula (2), Z¹ represents an electron-withdrawing group having a Hammett's substituent constant σp value of 0.20 or more; Z² represents a hydrogen atom, an aliphatic group, an aromatic group, or a heterocyclic group; Q represents a hydrogen atom, an aliphatic group, an aromatic group, or a heterocyclic group; R³ and R⁴ each independently represent a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group, or a sulfamoyl group; R¹ and R² each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclicamino group, an acylamino group, an ureido group, a sulfamoylamino group, an alkoxycarbonylamino group, an aryloxycarbonylamino group, an alkylsulfonylamino group, an aryl sulfonylamino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group; R¹ and R² may be bonded to each other to form a 5-membered or 6-membered ring; R³ and R⁴ may be bonded to each other to form a 5-membered or 6-membered ring; a and e each independently represent an alkyl group, an alkoxy group, or a halogen atom; when both a and e are each an alkyl group, the alkyl groups have 3 or more carbon atoms in total, and they may be further substituted; b, c, and d each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an alkylamino group, an arylamino group, a heterocyclic amino group, an acylamino group, an ureido group, a sulfamoylamino group, an alkoxycarbonylamino group, an aryloxycarbonyl amino group, an alkylsulfonyl amino group, an arylsulfonyl amino group, a nitro group, a thio group substituted by an alkyl, aryl or heterocyclic group, an alkylsulfonyl group, an arylsulfonyl group, an alkylsulfinyl group, an arylsulfinyl group, a sulfamoyl group, or a sulfo group; a and b may be fused with each other to form a ring; e and d may be fused with each other to form a ring; and formula (2) has at least one ionic hydrophilic group.

9. The ink jet recording method of claim 7, wherein the water-soluble aluminum compound is a polyaluminum chloride.

10. The ink jet recording method of claim 7, wherein the sulfoxide compound includes, in its molecule, one or more structures represented by the following formula (S1): [chemical structure]
